(19) United States
(12) Patent Application Publication
(10) Pub. No.: US 2026/0067205 A1
(43) Pub. Date: Mar. 5, 2026

(54) ENABLING SEGMENT ROUTING-BASED MOBILE NETWORKING FOR 6G

(71) Applicant: InterDigital Patent Holdings, Inc., Wilmington, DE (US)

(72) Inventors: Xavier De Foy, Kirkland (CA); Michael Starsinic, Newtown, PA (US); Rocco Di Girolamo, Laval (CA); Ulises Olvera-Hernandez, Saint-Lazare (CA); Sebastian Robitzsch, London (GB); Samir Ferdi, Kirkland (CA); Michel Roy, Candiac (CA)

(73) Assignee: InterDigital Patent Holdings, Inc., Wilmington, DE (US)

(21) Appl. No.: 18/825,764

(22) Filed: Sep. 5, 2024

(51) Int. Cl. H04L 45/302

(52) U.S. Cl. CPC H04L 45/302

(57) ABSTRACT

Methods, systems, and apparatuses to enable segment routing (SR) based mobile networking (MN), i.e., SRBMN in a mobile communication network are provided. A network node determines one or more SR enabled network paths for a user plane traffic and/or a control plane traffic. A segment identifier (SID) network function (SIDNF) is configured by a network operator with one or more SIDs. The SIDNF provides one or more mobile network SIDs (MN-SIDs) associated with the one or more SR enabled network paths to the node upon request. The one or more SR enabled network paths may include a WTRU, a WTRU to relay link, a WTRU to radio access network (RAN) link, and/or a RAN node to core network link etc. The WTRU may receive the one or more MN-SIDs and insert the one or more MN-SIDs in one or more protocol data units (PDUs) of a PDU session.

### BACKGROUND

Evolving mobile networks landscape requires support for increasingly complex services and also requires better integration between a mobile network overlay and a transport underlay. Currently, this integration is limited and restricted, and does not allow seamless network operation and optimization. Conventionally, segment routing (SR) over internet protocol sixth version (IPv6), i.e. SRv6 had been proposed as a solution to enhance this integration. The SRv6 enabled various traffic processing capabilities and provided compatibility with an existing IPv6 hardware. However, current SRv6 usage in the network underlay of a mobile network has many limitations that prevent full optimization of the mobile networks. In one such limitation, the mobile network overlay cannot utilize a network programming capability of the SRv6 to manage the traffic effectively. Additionally, when using SRv6 in the network underlay, the mobile network relies on stateful nodes, which limits scalability. Moreover, a differentiated quality of service (QoS) for the mobile network control plane is not supported when using the SRv6 in the network underlay. Therefore, there is a need to provide SR based mobile networking for the mobile networks.

### SUMMARY

In an embodiment, a method performed by a core network (CN) node is provided. The method includes receiving a request message. On a condition that the request message is indicative of one or more segment routing (SR) based mobile networking capabilities, the method includes determining use of an SR based mobile network (SRBMN). The method includes determining at least one of: one or more mobile network segment identifiers (MN-SIDs) or one or more SID rules. The method includes transmitting a response message comprising at least one of: the one or more MN-SIDs or the one or more SID rules.

In an embodiment, a CN node is provided. The CN node includes a memory, a transceiver, and a processor. The transceiver is configured to receive a request message. The processor is configured to, on a condition that the request message is indicative of one or more SR based mobile networking capabilities, determine use of an SRBMN. The processor is configured to determine at least one of: one or more MN-SIDs or one or more SID rules. The transceiver is configured to transmit a response message comprising at least one of: the one or more MN-SIDs or the one or more SID rules.

In an embodiment, the request message is indicative of at least one of: a protocol data unit (PDU) session establishment request, a PDU session modification request, or a network registration request.

In an embodiment, the response is indicative of at least one of: a PDU session establishment response, a PDU session modification command, a PDU session modification response, a network registration response, or a notification message.

In an embodiment, the request message is associated with a wireless transmit/receive unit. The request message is received from a radio access network (RAN) node. The response message is transmitted to the RAN node.

In an embodiment, determining at least one of: the one or more MN-SIDs or the one or more SID rules comprises determining a SR path based on the request message, and determining one or more segment identification information elements (SIIs) associated with the SR path.

In an embodiment, the node transmits, to an SID network function (SIDNF), an SID request message indicative of the one or more SIIs. The node receives, from the SIDNF, a response message indicative of at least one of: the one or more MN-SIDs or the one or more SID rules.

In an embodiment, the node receives a notification indicative of a change in the one or more SIIs. The node generates an updated SID request based on the change in the one or more SIIs. The node transmits the updated SID request to the SIDNF.

In an embodiment, the one or more SID rules include: the one or more MN-SIDs, a behavior information element (IE) indicative of a function for processing the one or more MN-SIDs, and one or more arguments associated with the function.

In an embodiment, determining the use of the SRBMN comprises: receiving one or more policies from a policy control function (PCF), and determining the use of the SRBMN based on at least one policy of the one or more policies.

In an embodiment, the CN node is a session management function (SMF) node.

In an embodiment, a wireless transmit/receive unit (WTRU) is provided. The WTRU includes a memory, a transceiver, and a processor. The transceiver is configured to receive, from a first radio access network (RAN) node, a policy message comprising a MN-SID label application policy. The MN-SID label application policy comprises a traffic detection portion and a label portion. The processor is configured to select a PDU session. On a condition that a PDU associated with the PDU session matches the traffic detection portion of the MN-SID label application policy, the processor is configured to insert, in the PDU, an MN-SID indicated by the label portion of the MN-SID label application policy. The transceiver is configured to transmit the PDU to the first RAN node.

In an embodiment, the WTRU inserts the MN-SID in each PDU associated with the PDU session. The WTRU transmits the each PDU to at least one of: the first RAN node or a second RAN node.

In an embodiment, the WTRU detects one or more traffic characteristics of one or more PDU sessions. The WTRU evaluates at least one WTRU route selection policy (URSP) comprising a traffic descriptor. The WTRU selects the PDU session of the one or more PDU sessions associated with a traffic characteristic of the one or more traffic characteristics that matches the traffic descriptor.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates an example mobile network deployed as an overlay network over a transport underlay, according to an embodiment;

FIG. 3 illustrates an example mobile network connectivity model for edge computing, according to one or more embodiments;

FIG. 4 illustrates an example mobile network deployed as an overlay network over a transport underlay, according to one or more embodiments;

FIG. 5 illustrates one or more example phases in a segment routing (SR) based mobile networking (SRBMN) operation for a user plane traffic and/or a control plane traffic, according to one or more embodiments;

FIGS. 6A-6B illustrates an example method for a user plane session establishment in an SRBMN system, according to one or more embodiments;

FIG. 7 illustrates an example method of a WTRU control plane session establishment in an SRBMN system, according to one or more embodiments;

FIG. 8 illustrates an example process of an SRBMN procedure for an edge computing, according to one or more embodiments;

FIG. 9 illustrates an example process performed by a core network (CN) node, according to one or more embodiments; and

FIG. 10 illustrates an example process performed by a WTRU, according to one or more embodiments.

### DETAILED DESCRIPTION

As discussed herein, one or more abbreviations in the following (non-exhaustive) list, shown in Table 1, may be used herein.

TABLE 1

| | |
|---|---|
| 5GLAN | 5G Local Area Network |
| 5GS | 5G System |
| AF | Application Function |
| AMF | Access and Mobility Management Function |
| AS | Application Server |
| ATM | Asynchronous Transfer Mode |
| ATSSS | Access Traffic Steering, Switching, Splitting |
| DA | Destination Address |
| DL | Downlink |
| GBR | Guaranteed Bit Rate |
| GPSI | Generic Public Subscription Identifier |
| GTP | Generic Tunneling Protocol |
| GTP-U | GTP User Plane |
| GUTI | Globally Unique Temporary Identifier |
| HTTP | Hypertext Transfer Protocol |
| ID | Identifier |
| IE | Information Element |
| IGP | Interior Gateway Protocol |
| IMSI | International Mobile Subscriber Identifier |
| IoT | Internet of Things |
| IP | Internet Protocol (IPv4: IP version 4, IPv6: IP version 6) |
| MA | Multi-Access |
| MAR | Multi-Access Rule |
| MN-SID | (Our Term) Mobile Network - SID |
| MPLS | Multiprotocol Label Switching |
| N4 | Interface defined by 3GPP between SMF and UPF |
| NAS | Non-Access Stratum |
| NF | Network Function |
| PCC | Policy and Charging Control |
| PDU | Protocol Data Unit |
| PIN | Personal IoT Network |
| PMF | Performance Management Function |
| ProSe | Proximity Services |
| PSA UPF | PDU Session Anchor UPF |
| QFI | QoS Flow ID |
| QoE | Quality of Experience |
| QoS | Quality of Service |
| QUIC | The QUIC protocol (not an acronym) |
| RAN | Radio Access Network |
| RG | Residential Gateway |
| RTT | Round Trip Time |
| SDAP | Service Data Adaptation Protocol |
| SDF | Service Data Flow |
| SID | Segment Identifier |
| SIDNF | (Our Term) SID Network Function |
| SII | (Our Term) Segment identification IE |
| SMF | Session Management Function |
| SR | Segment Routing |
| SRBMN | (Our Term) SR-based Mobile Networking |
| SRH | SR Header |
| SR-MPLS | SR for MPLS |
| SRv6 | SR for IPv6 |
| SUCI | Subscription Concealed Identifier |
| SUPI | Subscription Permanent Identifier |
| TE | Traffic Engineer |
| TLV | Type Length Value |
| UDP | User Datagram Protocol |
| UE | User Equipment |
| UL | Uplink |
| UL CL | Uplink Classifier |
| UPF | User Plane Function |
| URSP | UE Route Selection Policy |
| XR | Extended Reality |

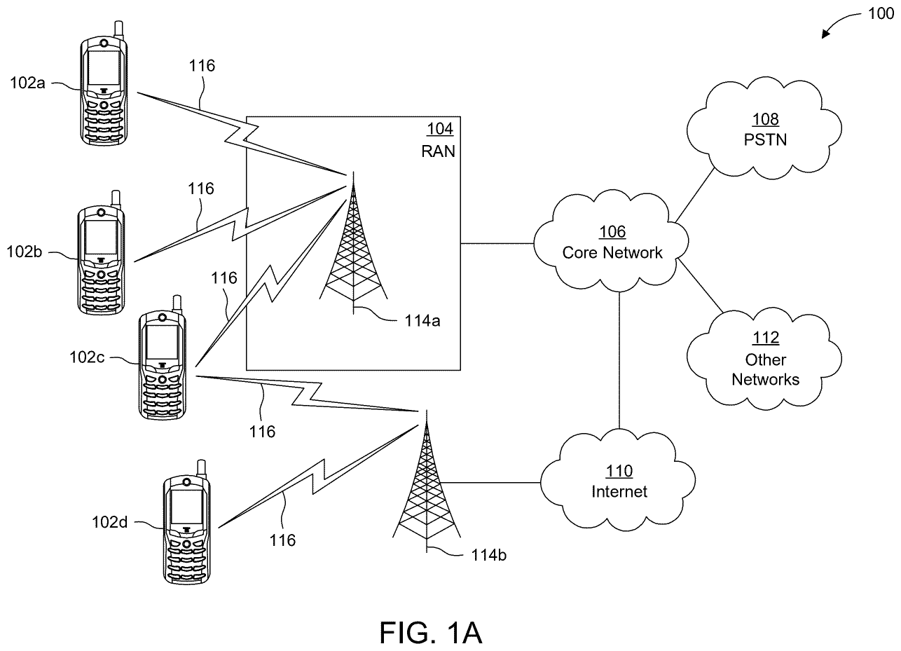

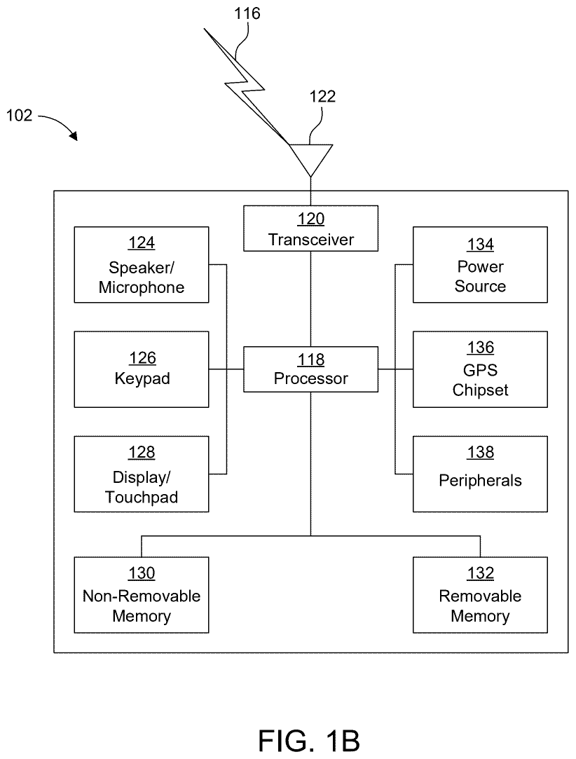

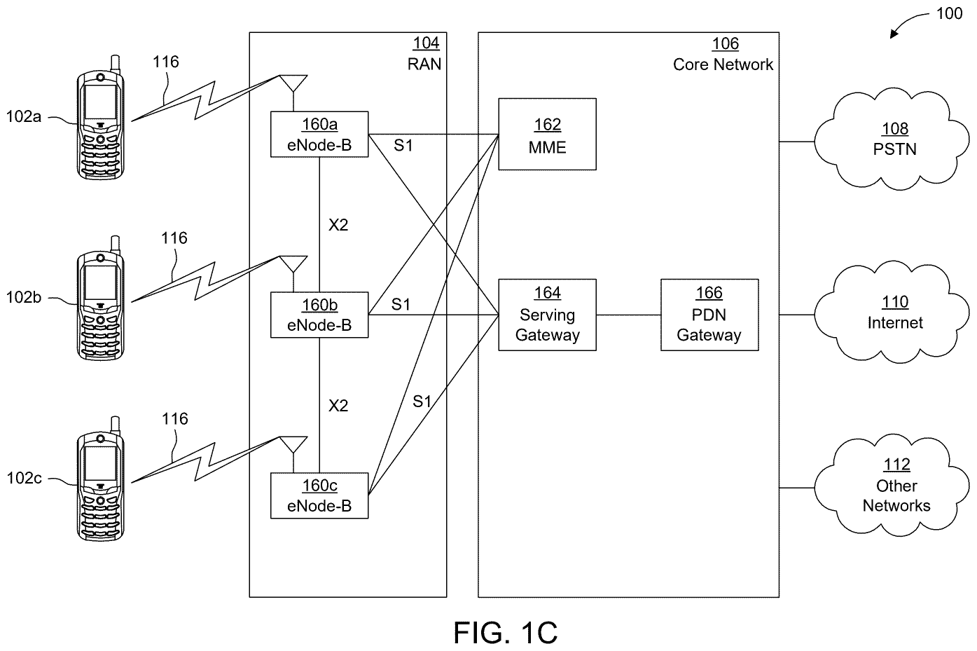

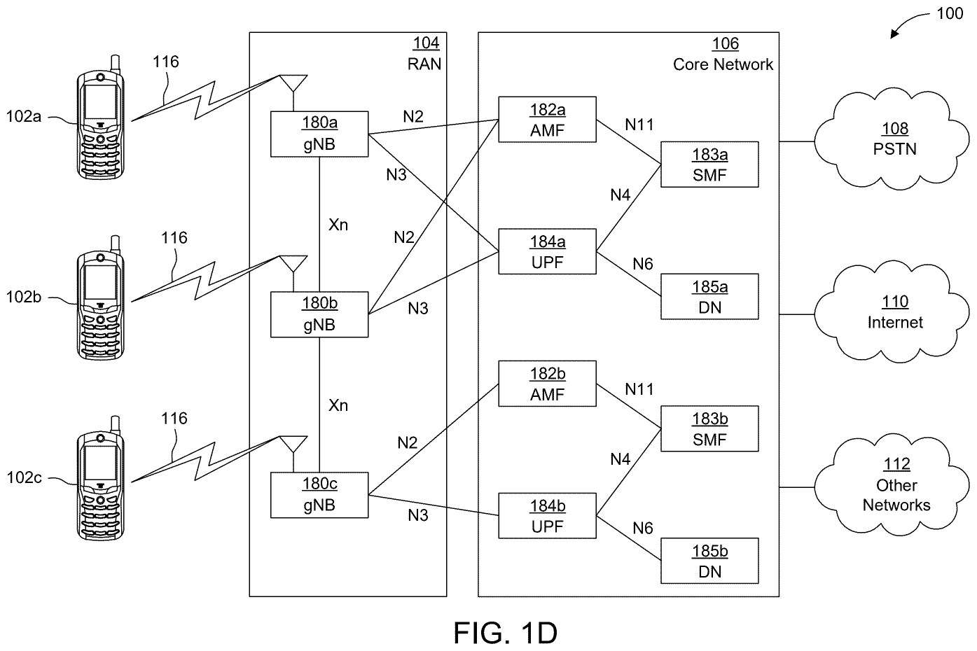

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 11B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11 ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11 af and 802.11 ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11 ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11 ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11 ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A mobile network determines one or more network paths for a user plane traffic and/or a control plane traffic, using one or more mobile network (MN) segment routing (SR) IDs (SIDs), i.e. MN-SIDs that describe one or more mobile network operations and/or one or more traditional (e.g., non-mobile network specific) SIDs (also simply referred to as “SIDs”). In an embodiment, one or more SR behaviors corresponding to one or more mobile network operations are described in the present disclosure. An SID network function (SIDNF), configured by a network operator with one or more SIDs and associated one or more information elements (IEs), provides the one or more SIDs to a session management function (SMF) upon request. In that, one or more SID based network paths may include a WTRU, one or more WTRU to relay links, one or more WTRU to radio access network (RAN) links, and/or one or more RAN node to core network links etc., for example. In an embodiment, one or more procedures to establish one or more control plane paths and/or one or more user plane paths are described in the present disclosure, including edge computing, for example.

In one or more embodiments, a user plane session establishment and/or a control plane session establishment in an SR-based mobile networking (SRBMN) network is provided. In one or more embodiments, the user plane session establishment for the edge computing, in the SRBMN network is provided.

A network node (e.g., the SMF and/or the AMF) determines a network path (including the one or more MN-SIDs), including which network services to apply on the network path, upon occurrence of an event. In an example, the event may include receiving a request for one or more user plane resources (e.g., a protocol data unit (PDU) session establishment request) and/or one or more control plane resources (e.g., a network registration request) and/or other types of events (e.g., mobility and/or addition of a new path etc.). The network node configures the one or more MN-SIDs in one or more data plane nodes (e.g. the WTRU, a RAN node, and/or a user plane function (UPF) etc.), using one or more policies (e.g. one or more MN-SID label application policies etc.) and/or by including the one or more MN-SIDs in a response message.

The network node may obtain, from the SIDNF function, the one or more MN-SIDs associated with the network path. The SIDNF may be configured by a network operator, with the one or more SIDs and with one or more segment identification IEs (SII) including one or more of: an area ID, a tracking ID, a network slice ID, an S-NSSAI, a WTRU ID, a node type, a link type, one or more QoS characteristics, a segment processing behavior, and/or topology information etc., for example.

The WTRU may include an SRBMN capability indicator in a network registration message and/or a PDU session establishment message and/or a modification message. The one or more MN-SIDs may include one or more new SR behaviors including but not limited to QoS handling, XR QoS handling, PDU set identification, multi-access steering, 5GLAN, and/or local data network routing etc., for example.

The term IE is used herein to represent one or more parameters. An IE may be made up of one or more other IEs.

The term SRv6 is used herein as an example of SR technology. One or more solutions described herein may be extended to other SR technologies such as but not limited to SR-MPLS etc.

The terms packets and/or PDUs are used interchangeably herein, to designate the control plane and/or the user plane unit of information transmitted over a network (e.g., a packet-switched network). In an example, the packets and/or the PDUs may include an IP packet and/or an Ethernet frame etc.

The term MN-SID is used herein to designate an SID configured by the mobile network. An MN-SID is also an SID, and the more general term SID may be used to designate the MN-SID in some cases described herein.

The term “access type” refers to whether an access is a 3GPP access or a non-3GPP access.

The term “local PSA UPF” and/or “local UPF” refers to the UPF that is located close the WTRU. The local PSA UPF and/or the local UPF may be used to reach a local data network. The “local data network” may be and/or include an “edge data network”. The “edge data network” is a data network that is located close to the WTRU and hosts services that may be used by an application that is running on the WTRU.

The terms RAN node, base station, gNodeB, and/or eNodeB may be used interchangeably.

In an example, the UPF is a gateway to a data network.

In an example, the SMF is a control plane node in a mobile core network that deals with session configuration and/or session management.

In an example, a policy control function (PCF) is a control plane node in the mobile core network that deals with policy creation and/or sending policies to the WTRU.

In an example, a central PSA UPF is the PSA UPF that is deployed in a central data network. The central data network is not necessarily deployed geographically close to the WTRU. When the WTRU accesses one or more services that are deployed in the edge data network the WTRU may expect that the one or more services run on one or more servers that may be geographically close to the WTRU and that therefore the traffic between the WTRU and services may experience relatively little delay. Whereas, when the WTRU accesses the one or more services that are deployed in the centralized data network (i.e. not the edge data network) the WTRU may not be able to expect that the traffic between the WTRU and the one or more services will experience relatively little delay.

In an embodiment, methods, systems, processes and apparatuses for the SR-based mobile networking are provided. The mobile network may associate one or more lists of the one or more MN-SIDs, which may define the network path (e.g. an SR enabled network path) of one or more segments, with a PDU session and/or with one or more control plane messages. The one or more lists may be added in one or more PDUs, and the one or more network services associated with each segment may be provided along the path of the packet.

In an implementation, the one or more MN-SIDs associated with the traffic (e.g., with the PDU session) are determined when the path is established (e.g., the PDU session establishment and/or at registration time for the CP etc.). In an embodiment, one or more methods of building one or more SID lists and/or one or more SID rules, using the SIDNF are provided.

In an example, the one or more MN-SIDs associated with the traffic are determined based on one or more triggers from the network (e.g., a mobility event). Here the one or more new policies including the one or more SID lists may be disseminated based on the one or more triggers.

In an embodiment, a method performed by a node, such as but not limited to the SMF, the AMF, and/or the PCF is provided. The node receives one or more SRBMN capabilities. The node receives a request for a network service, e.g., a PDU session establishment and/or a modification request and/or a network registration request etc. In an example, the request may also be another trigger, such as but not limited to receiving new policy information from the UDM, receiving a notification of the mobility event, and/or receiving the notification that a new path is available (e.g., new WTRU relay, new gNodeB, and/or new UPF etc.) etc., for example.

The node determines whether to use the SRBMN and also determines an extent of an SR domain (e.g., whether the SR domain includes the WTRU). The node also determines the one or more segment identification IEs (SIIs) that describe the SR path (e.g., including one or more types of segments and/or operations to apply to the traffic).

The node assembles (i.e. determines) the one or more MN-SIDs (e.g., for uplink (UL) and/or downlink (DL) traffic etc.). The node may also determine the one or more SID rules. In an example, the one or more MN-SIDs and/or the one or more SID rules may be determined using the SIDNF.

The node transmits, to the SIDNF, the request message including the one or more SIIs and possibly including an indication of the extent of the SR domain (e.g., whether the SR domain includes the WTRU).

The node receives, from the SIDNF, the one or more lists including the one or more MN-SIDs and/or the one or more lists including the one or more SID rules, indicative of the network path and/or the one or more network operations for the one or more network services.

The node transmits the one or more MN-SIDs and/or the one or more SID rules to the mobile network nodes, e.g. the UPF, the WTRU, and/or the RAN node etc.

In an example, the SR path may include but is not limited to (besides usual segments that are transport network segments) new segments implementing one or more mobile network-specific operations, the SR path may include the WTRU and/or one or more side links etc.

In an embodiment, a method performed by the WTRU is provided. The WTRU may transmit the UL traffic to the mobile network. In that, the WTRU may receive a policy message including a MN-SID label application policy. The WTRU may determine that a PDU matches a traffic detection part of the MN-SID label application policy. The WTRU may add the one or more MN-SIDs from a label part of the MN-SID label application policy to the PDU. The WTRU may evaluate one or more WTRU (i.e. UE) route selection policy (URSP) rules to determine what PDU session to use to transmit the UL traffic. The WTRU may transmit the data packet including the PDU and/or the one or more MN-SIDs to the mobile network. The WTRU may change a point of attachment to the mobile network (e.g., the RAN node). The WTRU may transmit another PDU using the same one or more MN-SIDs.

In an embodiment, a method performed by the SIDNF is provided. The SIDNF may receive a configuration including the one or more SIDs and/or the one or more SIIs associated with the one or more SIDs. The SIDNF may receive a notification that a new segment is available for the traffic (e.g., new relay to/from the WTRU). The SIDNF may transmit the notification that the new segment is available (e.g., to the SMF), including the one or more SIIs identifying context about the new segment (e.g., a WTRU ID identifying the WTRU towards which the new path is available). The SIDNF may receive an MN-SID list request message including the one or more SIIs identifying the network path to be updated. The SIDNF determines the list of the one or more MN-SIDs matching the one or more SIIs and/or requests the mobile network to create the one or more MN-SIDs matching the one or more SIIs. The SIDNF may transmit an MN-SID list response message including the list of the one or more MN-SIDs, describing a network path for a network service.

In an embodiment, a method performed by a data plane node, the RAN node, and/or the UPF is provided. In an example, the data plane node, the RAN node, and/or the UPF receives a first SID rule for a first SID (i.e. SID1), including a mobile-network specific behavior code (e.g., a QoS handling, an XR QoS handling, a PDU set identification, a multi-access, 5GLAN, and/or a local data network routing etc.). In an example, the data plane node, the RAN node, and/or the UPF may configure itself to implement the behavior when receiving the packet and/or the PDU having internet protocol (IPv6) destination address (DA) as SID1. The data plane node, the RAN node, and/or the UPF may receive the packet and/or the PDU having IPv6 DA is SID1 including one or more arguments.

In an example, if the behavior is indicative of the QoS handling, the one or more arguments may include a PDU session ID, a QoS identifier code, a reflective QoS indication, and/or a radio bearer type and/or ID etc. In an example, if the behavior is indicative of the XR QoS handling, one or more arguments may include the PDU set information, a burst information, QoS information, and/or charging related information (e.g., an indication to pause and/or resume charging) etc. In an example, if the behavior is indicative of the PDU set identification, the one or more arguments may include a protocol ID that identifies the method of PDU set identification, and/or a flow ID (e.g., PDU session ID) etc. In an example, if the behavior is indicative of the multi-access, the one or more arguments may include a multi-access steering functionality, a multi-access steering mode and/or one or more configuration IEs for the steering mode, and/or an SR policy ID etc. In an example, if the behavior is indicative of the 5GLAN, the one or more arguments may be indicative of a 5GLAN ID, a source WTRU ID (e.g., a subscription permanent identifier (SUPI), a subscriber concealed identifier (SUCI), a global unique temporary identifier (GUTI), a generic public subscription identifier (GPSI), and/or an international mobile subscriber identity (IMSI) etc.) and/or a hash value of a source WTRU ID etc. In an example, if the behavior is indicative of the local data network routing, the one or more arguments may include a local DNN, a non-local DNN, and/or a local DNN filter etc.

The data plane node, the RAN node, and/or the UPF may process the data flow packet according to the SID rule corresponding to SID1. In an example, if the behavior is indicative of the QoS handling, the data plane node, the RAN node, and/or the UPF may select a radio bearer based on a radio bearer type and/or the one or more arguments and forward the PDU over the selected radio bearer. In an example, if the behavior is indicative of the XR QoS handling, the data plane node, the RAN node, and/or the UPF may perform a PDU set QoS handling using the one or more IEs provided as the one or more arguments.

In an example, if the behavior is indicative of the PDU set identification, the data plane node, the RAN node, and/or the UPF may identify one or more PDU set IEs and make the one or more PDU set IEs available for XR handling (e.g., write the one or more PDU set IEs in a packet header as the one or more arguments to the XR QoS handling SID etc.). In an example, if the behavior is indicative of the multi-access, the data plane node, the RAN node, and/or the UPF may forward the PDU over an access selected based on the one or more arguments including the steering functionality, the steering mode and/or the one or more configuration IEs for the steering mode etc. In an example, if the behavior is indicative of the 5GLAN, the data plane node, the RAN node, and/or the UPF may, based on the one or more arguments, verify that a sender is a member of a 5GLAN group, and/or encapsulate the PDU in an outer IP packet and forward the encapsulated PDU, and/or decapsulate the PDU from an outer IP packet and forward the decapsulated PDU etc. In an example, if the behavior is indicative of the local data network routing, the data plane node, the RAN node, and/or the UPF may forward the packet to a local DN if accessible and/or otherwise to a non-local DN etc.

In an embodiment, most WTRUs are capable of supporting both 3GPP access type and non-3GPP access type. This capability provides flexibility to the network operator in determining which access to use for a service data flow (SDF). A multi-access PDU session (MA PDU session) allows uplink and downlink traffic of a service data flow to be steered, switched, and/or split between accesses. A MA PDU session is a PDU session whose traffic may be transmitted over the 3GPP access and/or over the non-3GPP access, and/or over both the accesses. This architecture may provide traffic steering, where an access network is selected for a new data flow and the traffic of this data flow is transferred over the selected access network. The architecture also provides traffic switching, where an ongoing data flow may be moved from one access network to another access network in a way that maintains a continuity of the data flow. The architecture also provides traffic splitting, where the traffic of the data flow may be split across multiple access networks. In an example, the one or more PDUs of the data flow may be transmitted via one access and some other PDUs of the same data flow may be transmitted via another access.

The traffic steering functionality, which resides in an ATSSS-capable WTRU and/or in the UPF, may steer, switch, and/or split the MA PDU session traffic across multiple accesses. In an example, three steering functionalities have been standardized; two high-layer steering functionalities, which operate above the IP layer, have been standardized: a MPTCP steering functionality applies to a TCP traffic; a MPQUIC steering functionality is applicable to a UDP traffic. A low-layer steering functionality, which operates below an IP layer, has been standardized: the ATSSS low-layer functionality (ATSSS-LL) applies to the Ethernet and the IP traffic. The traffic steering mode may also determine how the traffic of the matching service data flow should be distributed across accesses. In an example, only one steering mode can may be used for the SDF. An active-standby steering mode may steer the traffic on one access (i.e. an active access) when this access is available, and switch the traffic to another access (i.e. a standby access) when the active access becomes unavailable. A smallest delay steering mode may steer the traffic to the access that is determined to have the smallest round-trip time (RTT). The WTRU and/or the UPF may measure the RTT to determine which access has a lowest RTT. The smallest delay steering mode may be used for a non-GBR SDF. A load balancing steering mode may split the traffic across both the accesses according to a configurable percentage. When an autonomous load-balance indicator is provided by the network, the WTRU may autonomously determine one or more percentages for the traffic splitting. The load-balancing may be applicable to the non-GBR SDF. A priority based steering mode may steer all the traffic matching a PCC rule to a high priority access, until the access is determined to be congested. In this case, the traffic may also be sent to a low priority access, i.e., the traffic may be split over the two accesses. The load-balancing may be used for the non-GBR SDF. A redundant steering mode may allow the WTRU and/or the UPF to duplicate traffic over both access legs of the MA PDU session.

An additional configuration may be provided by the network to modify a traffic steering mode behavior on the WTRU and/or the UPF. In an example, a WTRU-assistance indicator may enable the WTRU to decide how to distribute the UL traffic in some cases (e.g., when in a low battery mode). A threshold value (e.g. the RTT and/or a packet loss rate etc.) may enable the WTRU and/or the UPF to reduce usage on the access when the threshold value is reached on the access. For the MPQUIC steering functionality, a configuration item may enable transporting a stream and/or datagram without reordering, and/or a datagram with reordering.

A performance management function (PMF) protocol may be used between the WTRU and the UPF to make the measurements necessary for the switching mode decisions (e.g., the RTT, access availability report, and/or packet loss rate etc.).

A selection of the traffic steering functionality and/or the traffic steering mode for the SDF in the MA PDU session may be performed by the SMF, based on a MA PDU session control information present in a PCC rule. The MA PDU session control information may include the traffic steering mode and/or functionality, as well as additional configuration parameters, as described above.

It is challenging for a wireless network to carry media flows, especially for applications with high-throughput and low latency requirements, such as video conferencing and Extended Reality (XR). The wireless network may implement one or more techniques to improve a network capacity and an energy efficiency, as well as reduce an impact of packet losses on user experience. In an example, the wireless networks such as 5G may handle one or more groups of packets based on how critical they are to the user experience.

Some groups of data packets may hold application data units that are handled together (e.g., decoded) by an application, and that are referred to as a “PDU set”. The PDU set may, for example, correspond to the one or more PDUs carrying a single complete network application layer unit.

To support high-throughput low-latency media flows, the network (e.g., the RAN) may perform differentiated and/or integrated QoS handling of the XR traffic. This may include prioritizing the one or more PDU sets over others in case of congestion. The network may also use dependency of one or more application data units on other application data units to be handled and/or decoded by the application (e.g., P-frames depend on I-frames and/or enhancement layers depend on base layers etc.). The network may also selectively drop data packets that depend on an already lost application data unit. The network may limit wake-up time (of one or more radios) to transmit and/or receive data. In an example, a packet scheduler (e.g., in the RAN node) and/or the WTRU may synchronize the transmission and/or listening times using information on the size and/or a periodicity of the traffic, and/or a delay budget and an expected jitter specific to the application.

The RAN may perform differentiated and/or integrated QoS handling of the XR traffic based on the differentiated and/or integrated handling IEs associated with the flow and/or the one or more PDU sets inside the flow. The differentiated and/or integrated handling IEs may include PDU set QoS parameters received via the control plane and/or the PDU set information received via the user plane. In an example, for the downlink traffic, the PDU set information may be sent by the UPF to the RAN node via a generic tunneling protocol (GTP) user plane (UP), i.e. GTP-U header of a user plane packet. In an example, for the uplink traffic, the PDU set information may be provided by a WTRU application through an SDAP interface.

The term PDU set IE may be used to represent the one or more IEs described herein as the PDU set information and/or the PDU set QoS parameters. The PDU set information may include a PDU set ID. The PDU set ID is an identifier of a PDU set. The PDU set ID uniquely identifies the PDU set within the flow at least for a duration corresponding to the transmission time of the one or more PDUs between the sender and/or the receiver. The PDU set ID may be, e.g., a numerical ID and/or a timestamp etc.

The PDU set information may include a start and/or an end of the PDU set indication. These IEs may identify a first and/or a last PDU(s) of the PDU set.

The PDU set information may include a PDU sequence number within the PDU set. These IEs may identify a PDU within the PDU set, e.g., a numerical ID starting at 0 for the first PDU and incremented by one for each PDU in the set.

The PDU set information may include a PDU set size. These IEs may be indicative of a total number of PDUs, and/or a cumulative length of all PDUs in the PDU set, and/or a cumulative length of all PDU payloads (e.g., a transport payload) in the PDU set.

The PDU set information may include a PDU set importance. These IEs may be a numerical value indicative of an importance level of the PDU set within a service flow (e.g., from highest priority value 0 to lowest priority value 255). The RAN may use the PDU set importance for PDU set level packet discarding in case of congestion.

The PDU set information may include an end-of-burst indication. These IEs may indicate that the PDU and/or the PDU set is the last PDU and/or the last PDU set of a burst. These IEs may also include one or more IEs indicating an amount of time before the next burst.

The PDU set information may additionally include an XR application session ID, which may identify the session, e.g., to provide a scope for prioritizing, scheduling, and/or synchronizing flows, packets and/or PDU sets.

The PDU set information may include an XR application session priority, which may provide a priority for inter-session prioritization, e.g., to prioritize between flows belonging to different application sessions, which have a same flow priority.

The PDU set information may include an XR flow ID, which may identify the flow, e.g., for applying XR service on the flow. The XR flow ID may be provided by the mobile network, e.g., the XR flow ID may be a PDU Session ID.

The PDU set information may include an XR flow priority, which may provide a priority for inter-flow prioritization.

The PDU set information may include a data type, e.g., audio, video, and/or haptic data etc. The data type may be used for inter-flow synchronization, e.g., to determine an acceptable synchronization delay between flows.

The PDU set information may include an XR synchronization group ID, which may indicate which flows of the application session may be synchronized with each other.

The PDU set information may include a list of applicable network services, which may indicate which network services, e.g., including a PDU QoS set handling, but may also include additional services, such as but not limited to increased reliability (e.g., using multipath connectivity such as provided by the ATSSS), and/or low-latency delivery, etc. The PDU set information may be used by the 5G network to determine which level of service can be provided to a given PDU set.

The PDU set information may include a PDU set type, which may enable associating a domain-specific meaning with the PDU set, e.g., I-frame, P-frame, and/or B-frame etc. The PDU set type may be used to provide one or more XR services where specialized processing is required for selected types of PDU sets.

The PDU set information may include one or more PDU FEC parameters, including an FEC algorithm and one or more corresponding parameters. The one or more FEC parameters may be used, e.g., by the WTRU, the UPF, and/or the AS to recover one or more lost packets in the PDU set protected by the FEC.

The PDU set information may include a PDU parent set ID, which may identify a parent PDU set that may be required to be received by the application, for the (child) PDU set to be usable by the application.

The PDU set information may include one or more timing IEs such as but not limited to a media unit timestamp, a presentation timestamp, sending a time timestamp, an accumulated transmission delay, and/or a PDU synchronization ID. The PDU synchronization ID may identify a group of inter-related PDUs that may be presented to the user at a similar time, within the same flow (e.g., a set of frames that may be presented to the user at the same time in a multi-screen setup), and/or between different flows (e.g., a video PDU that may be presented to the user together with haptic PDU).

The one or more IEs may include one or more PDU set QoS parameters. The one or more PDU set QoS parameters may include a set of parameters to configure the QoS handling of a flow.

The one or more PDU set QoS parameters may include a PDU set error rate. The PDU set error rate may correspond to one or more error rates applicable to the one or more PDU sets (e.g., where a PDU set loss corresponds to an event where at least a PDU of the set could not be transmitted successfully). The PDU set error rate may be used to configure an acceptable error rate for the one or more PDU sets of the service flow and/or the QoS flow in the RAN.

The one or more PDU set QoS parameters may include a PDU set delay budget. The PDU set delay budget may correspond to the acceptable delay for transmitting a full PDU set (e.g., from the reception of the first PDU of the PDU set, to the transmission of the last PDU of the PDU set). The PDU set delay budget may be used to configure the delay budget for the service flow and/or the QoS flow in the RAN.

The one or more PDU set QoS parameters may include a PDU set integrated indication. The PDU set integrated indication may indicate whether all PDUs of the PDU set are needed by the application.

The one or more PDU set QoS parameters may include a burst periodicity. The burst periodicity may designate a period of a data burst for the flow (e.g., a transmission period for a plurality of consecutive independent frames in a video stream and/or transmission period for a group of pictures etc.).

The PDU set identification may determine which PDU set the PDU belongs to, along with one or more identifying PS IEs associated with the PDU set. In an example, for non-encrypted media flows (e.g., using an RTP protocol), the identification may be performed by the UPF for the downlink flows. In an example, for encrypted media flows, the identification may be performed both by the media sender (e.g., an origin media server and/or a proxy with an access to transport metadata), and/or by the UPF (e.g., based on the metadata placed in the PDU by the media sender, which is visible by the UPF).

The PDU set QoS handling may designate the operation (in the RAN and/or possibly in the UPF) that includes providing differentiated handling depending on one or more PS IEs. In an example, dropping the one or more PDUs of lower PS importance in case of congestion.

In the 5GLAN, the SMF may configure one or more UPFs to apply different traffic forwarding methods to route the traffic between the one or more PDU sessions for a single 5G VN group. In an example, such a feature may be referred to as a 5G VN group communication, i.e. the 5GLAN. In an example, depending on the destination address, some packet flows may be forwarded locally, while other packet flows may be forwarded via N19 (i.e., a user plane reference point between two PSAs) and other packet flows may be forwarded to N6 (i.e., the user plane reference point between a PSA and the data network).

The 5G VN group communication may include one to one communication and one to many communication. The one to one communication may support forwarding of a unicast traffic between two WTRUs within the 5G VN, or between the WTRU and a device on the DN. The one to many communication may support forwarding of a multicast traffic and/or a broadcast traffic from the WTRU (and/or the device on the DN) to many and/or all WTRUs within the 5G VN and the devices on the DN.

A traffic forwarding within the 5G VN group may be realized by using a UPF internal interface (e.g. “5G VN internal”) and a two-step detection and/or forwarding process. In a first step, the one or more packets received from any 5G VN group member (via corresponding PDU Session, via N6 and/or via N19 etc.) may be forwarded to the UPF internal interface (i.e. destination interface set to the “5G VN internal”). In a second step, one or more PDRs installed at the UPF internal interface (i.e. a source interface set to the “5G VN internal”) detect the packet and/or forward the packet to the respective 5G VN group member (via the corresponding PDU session, via N6 and/or via N19 etc.).

In an example, for one or more WTRUs belonging to the same 5G VN group and having PDU sessions that correspond to N4 sessions in the same PSA UPF, for the traffic that is sent from one of the WTRUs to another one of the WTRUs using local switching, the incoming traffic for one PDU session may match one or more corresponding N4 session PDRs of the source PDU Session (e.g. based on a GTP-U header information). The traffic may be then sent back to classification in that UPF (e.g. via the internal interface) and may match another N4 session corresponding to the destination PDU session (based on the destination address in the PDU). The PDU may then be forwarded to the target WTRU.

In an embodiment, segment routing (SR) is a routing technique based on use of one or more segments, which are instructions which an SR node executes. Several implementations of the SR are currently defined, including IPv6-based SR and/or MPLS-based SR (SR-MPLS). The one or more segments may be identified by respective one or more segment identifiers (SIDs), a format of which may depend on an implementation, e.g., an MPLS label and/or an IPv6 address. The one or more SIDs may be unique within an SR domain. Each packet may include a list of segments, referred to as a segment list and/or an SID list. In an example, one instruction and/or segment may be active at a given time, referred to as an active segment.

The SRv6 may be applied using an IPv6 extension header referred to as a segment routing header (SRH). The SRH may include the segment list and/or other IEs that enable SR capable nodes to operate, including a “segments left” field that points to the active segment in the segment list. When the processing of the segment is complete, the SR node may decrease a “segments left” field and may copy a new active segment into the IPv6 destination address field of the IPv6 header. The SRH may also include one or more type-length-values (TLVs) that may be used to encode one or more additional parameters.

Within the SR domain, three types of nodes may be defined: source node, transit node, and/or endpoint node. The source node may transmit the IPv6 packet with the SID as the destination address. The source node may be a host originating the packet, or the source node may be an SR domain ingress router that encapsulates a received packet in an outer IPv6 header followed by an optional SRH. The transit node forwards the IPv6 packet where the destination address of that packet is not locally configured as the segment and/or the local interface. The segment endpoint node receives the IPv6 packet where the destination address of that packet may be locally configured as the segment and/or the local interface.

In the SRv6, the SID may include a (128 bit) IPv6 address. The SID may include three portions: a locator (LOC) that is encoded in L most significant bits of the SID, followed by F bits of function (FUNCT) and A bits of arguments (ARG). The operator may select any locator length L. F and A may be any value if the sum of L, F and A remains lower than 128.

When the sum is less than 128, the remaining bits of the SID may be set to zero.

In an example, the SR policy may include an ordered list of one or more segments, instantiated at a node referred to as a headend node. The headend node may steer the packet flows into the SR policy, ultimately towards an endpoint. The SR policy may be identified through a tuple (i.e. the headend, a color, and/or an endpoint etc.), where the color may be an integer value that associates the SR policy with an intent and/or objective (e.g., the low latency etc.). The SR policy may correspond to multiple candidate paths, each corresponding to one or more segment lists. In an example, one candidate path may be active at a given time.

A binding SID (BSID) may be an SID bound to the SR policy. The BSID may summarize the SR policy using a single SID in the segment list. When an SR router receives the packet with the active segment equal to the BSID, the node may steer the packet onto the bound SR policy. In an example, the router may encapsulate the packet in an outer IPv6 header and an SRH.

In an example, for TE, the SR may provide associating one or more algorithms to one or more prefix SIDs, for example enabling one or more IGPs to compute constraint-based paths over the network (e.g., one or more flex-algorithms that may be used to compute a shortest path based on one or more TE parameters such as latency and/or throughput). Furthermore, the SR policy may express the path through a transport layer beneath IP (e.g., ATM).

In an embodiment, one or more techniques to enable reducing the overhead from the SRH header in each packet, for example by compressing the segment list encoding are provided.

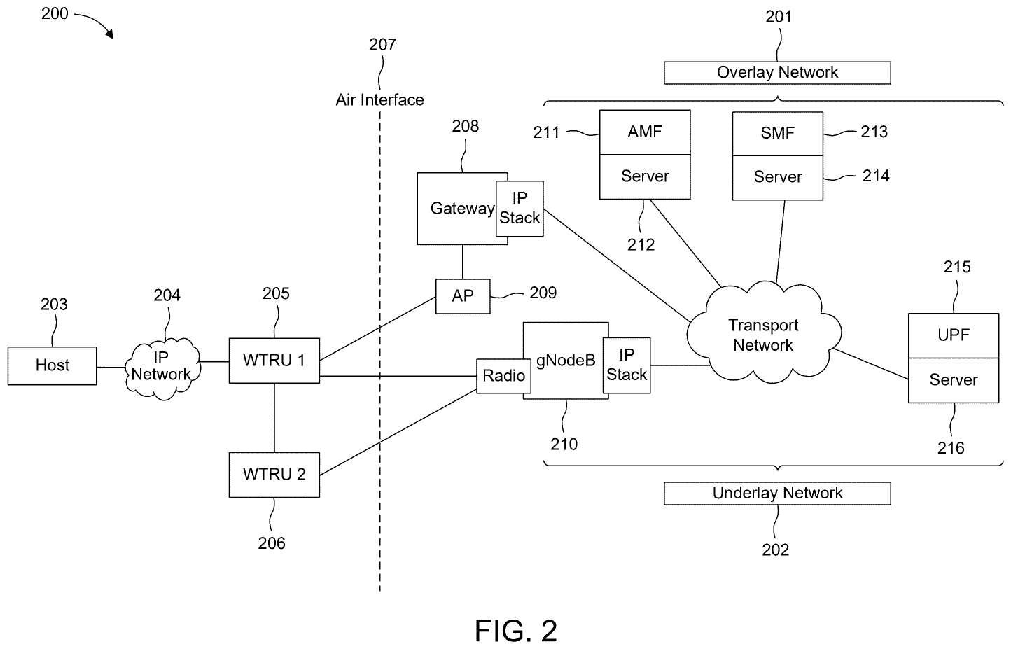

FIG. 2 illustrates an example mobile network 200 deployed as an overlay network 201 over a transport underlay 202, according to an embodiment. The mobile network 200 may include a host 203, an IP network 204, a first WTRU 205, a second WTRU 206, a gateway 208 coupled to an access point (AP) 209, a GNB 210, an AMF 211 coupled to a server 212, an SMF 213 coupled to a server 214, a UPF 215 coupled to a server 216. As illustrated in FIG. 2, the mobile network 200 (e.g., including the one or more RAN nodes and/or the one or more core network nodes) may be deployed over the underlay transport network 202, e.g., one or more mobile nodes may be connected to one or more routers in the transport network 202 (the underlay transport network 202), and may have interactions with each other via the one or more routers in the transport network. The SRv6 may be used to operate the underlay transport network 202 to carry one or more mobile user plane PDUs. In an example, the SRv6 may be used to implement the GTP-U tunnels between the RAN node and the UPF 215, and/or between two UPFs. An underlay network operator may determine which segments (e.g., which links and/or network services) to use for the traffic flow, based on one or more attributes exposed by the mobile network overlay 201, e.g., at the gNodeB 210 and/or the UPF 215, including a network slice and/or a QFI, etc.

A mode of operation of the SRv6 for mobile networks supports unmodified gNodeBs, while other modes rely on a SRv6-aware gNodeB and the UPF, including using a “traditional” mode which does not support additional intermediate segments, and an “enhanced” mode which supports the additional intermediate segments.

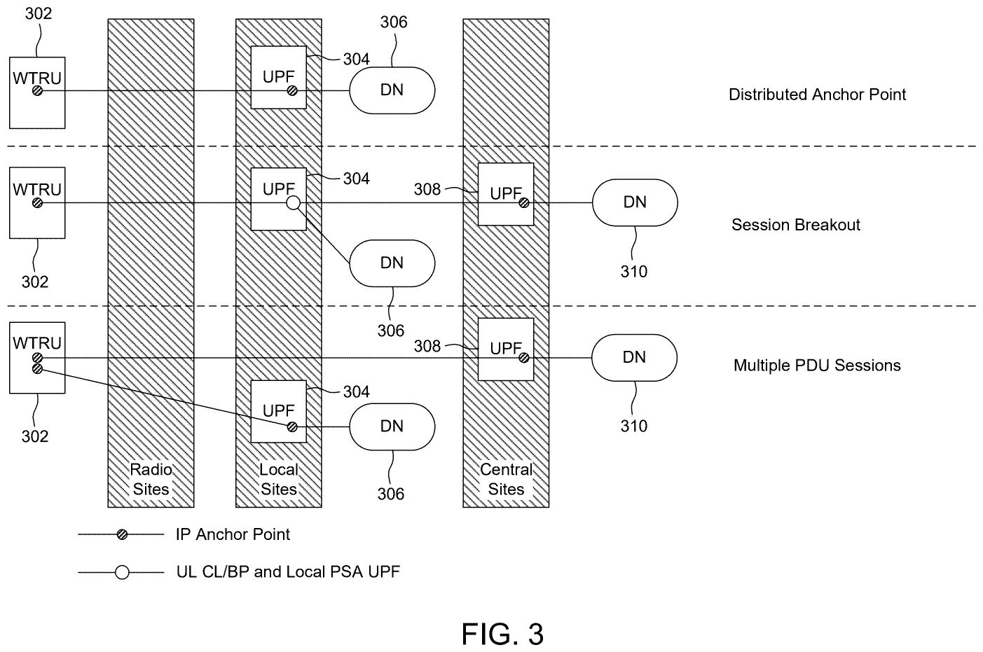

FIG. 3 illustrates an example 5GC connectivity model for edge computing, according to one or more embodiments. FIG. 3 illustrates at least one WTRU 302, at least one first UPF 304, at least one first DN 306, at least one second UPF 308, and at least one second DN 310. FIG. 3 illustrates examples of various WTRU connectivity models that may be used for edge computing.

In a distributed anchor point connectivity model, the PSA UPF (i.e. the first UPF 304) may be deployed in a location that is close to the WTRU. In a session breakout model, the PDU session of the WTRU 302 has multiple PSA UPFs. One PSA UPF may be in a central site while the other one or more PSA UPFs may be deployed in sites that are close to the WTRU 302. In a multiple PDU sessions model, the WTRU 302 establishes multiple PDU sessions and each PDU Session has one or more PSA UPFs in locations that are close to the WTRU 302.

When the session breakout connectivity model is used, the SMF of the PDU session may decide when to add and/or remove the one or more PSA UPFs to and/or from the PDU session. In an example, the SMF may decide to add and/or remove the one or more PSA UPFs when the SMF detects that the location of the WTRU has changed. In an example, the SMF may decide to add and/or remove the one or more PSA UPFs when the SMF detects a new application flow in the PDU session.

In an example, the SMF may detect that the location of the WTRU has changed such that the WTRU is no longer connected to the network via a first RAN node and is now connecting to the network via a second RAN node. Based on an application layer traffic that the SMF detects in the PDU session and information that is configured in the SMF about edge services that are geographically close to the second RAN node, and reachable via the second RAN node, the SMF may decide to add a second PSA UPF to the PDU session and/or add a branching point UPF to the PDU session so that certain application traffic from the WTRU is routed towards the second PSA UPF. The second PSA UPF may be used to send and/or receive traffic between the WTRU and an edge data network.

In an example, one or more procedures for adding an additional PDU session anchor and branching point or UL CL, removing an additional PDU session anchor and branching point or UL CL, and changing an additional PDU session anchor and branching point or UL CL may be used.

Therefore, there is a need for better integration between the mobile network overlay and the transport underlay, compared to limited integration at the GTP-U tunnel endpoint. Conventionally, The SRv6 had been proposed to enable a tighter integration. The SRv6 enabled a simplification of the network by replacing multiple traffic engineering and tunneling protocols, enables programming advanced traffic processing in the network, and being compatible with existing IPv6 hardware. However, the conventional SRv6 solution can still be improved. Firstly, the integration between the mobile network overlay and the transport underlay is still limited in the conventional SRv6. For example, the network programming capability offered by the conventional SR is not available to the mobile network itself. The overlay mobile network is not able to program, using the one or more SIDs, one or more mobile network services for user and/or control plane traffic flows in the conventional SR. Additionally, the overlay mobile network is not able to interleave the one or more mobile network SIDs with one or more transport network SIDs in the conventional SR. Therefore, there is a need to associate with a PDU session, a chain of operations including 5GLAN, ATSSS, XR QoS handling and/or possibly additional network services.

Further, since the conventional mobile network relies on stateful nodes to carry user plane traffic, there is an opportunity to define new types of segments that support stateless operations. Statelessness enables load balancing, and more generally high scalability.

The conventional mobile network does not support differentiated QoS for control plane traffic. Therefore, there is an opportunity for the mobile network to define paths for control plane traffic, which provide different QoS guarantees, and therefore enable control plane messages to be associated with a QoS.

Secondly, the integration between the conventional mobile network overlay and the transport underlay does not reach the WTRU or more generally one or more network elements beyond the air interface. Typically, when the conventional SRv6 is used in the mobile network underlay, the SRv6 domain spans from the RAN nodes (e.g., the gNodeB and/or WiFi trusted or untrusted AP) to the anchor UPF. This does not include the WTRU, PIN elements, home networks through RG, tethered devices, or other WTRUs through the side link (e.g., for proximity services). In an example, not including in the SRv6 domain the network nodes in home and/or corporate network operator on a WTRU side of the air interface prevents programming an end-to-end path from a home and/or corporate device to an AS, using the SR.

To address the limitations identified above, the present disclosure provides methods, apparatuses, systems, and procedures to enable SR-based mobile networking, where the mobile network associates one or more network segments (identified by the one or more SIDs) with one or more mobile network flows. Some segments may correspond to one or more mobile network functionalities such as but not limited to QoS handling, XR QoS handling, access steering, switching, splitting, and/or 5GLAN etc. Some SIDs determined by the mobile network may correspond to the one or more SIDs defined by the underlay network operator. However, the coupling between the underlay network and the overlay network may remain limited, to enable both networks to be managed separately, possibly by different operators.

In an embodiment, methods and procedures are provided to further extend SR-based mobile networking to include segments on the WTRU side of the air interface, e.g., including the WTRU, the one or more PIN elements, one or more home networks through the residential gateway (RG), one or more tethered devices, and/or one or more other WTRUs through the side link.

In an embodiment, methods and procedures for the SR-based mobile networking (SRBMN) are described herein. In an example, one or more user plane paths are network paths for the one or more PDU sessions and one or more control plane paths are one or more network paths for one or more control plane messages. An SRBMN system is a mobile network that configures the one or more user and/or control plane paths using segment routing identifiers. The mobile network SID (MN-SID) is a segment ID, configured in the (e.g., overlay) mobile network and which is processed in the mobile network node (e.g., the RAN node, the WTRU, the UPF, and/or the core network node etc.). Collectively, the term MN-SIDs may also be used herein to designate a mixed set of SIDs including the one or more SIDs processed in the mobile network nodes and in the underlay network nodes (e.g., the SR routers).

When using the SRBMN, the network node (e.g., the SMF, PCF, and/or a new NF) associates the list of MN-SIDs with the PDU session, e.g., when establishing and/or updating the PDU session, or with the one or more control plane messages, e.g., during network registration. In some systems, the network node may alternatively configure other nodes (e.g., the WTRU, the RAN node, and/or the UPF etc.) ahead of time with policy including the one or more MN-SIDs, which enables associating, on-demand, the list of MN-SIDs with the PDU session. In some systems, the network node obtains the one or more MN-SIDs from the SIDNF and/or from configuration. To enable inserting the one or more MN-SIDs in the one or more PDUs, the network node provides the one or more MN-SIDs to the one or more mobile network nodes including one or more CN nodes, one or more RAN nodes and/or one or more WTRUs, over the mobile network control plane (e.g., in response messages for the PDU session establishment and/or registration, or in policy configuration messages). To program the behavior for processing the one or more MN-SIDs, the one or more SID rules including the one or more MN-SIDs are configured in mobile and one or more underlay network nodes, e.g., over the management plane and/or over the mobile network control plane. The one or more mobile network nodes add the one or more SIDs derived from (or equal to) the one or more MN-SIDs to one or more packets (e.g., one or more UP PDUs or one or more CP messages), in the SR header. The mobile and/or underlay network nodes may apply the one or more network services based on the one or more SIDs present in the one or more packets, based on the one or more SID rules.

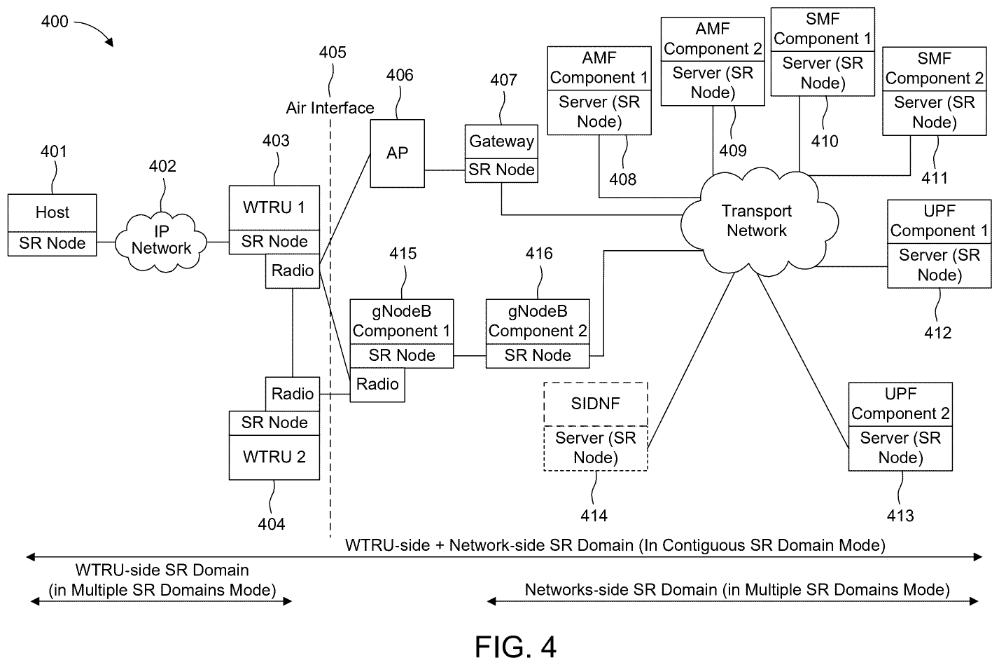

FIG. 4 illustrates an example mobile network 400 deployed as an overlay network over a transport underlay, according to one or more embodiments. The mobile network 400 includes a host 401, an IP network 402, a first WTRU 403, a second WTRU 404, an air interface 405, a gateway 407, first and second AMF components 408 and 409, first and second SMF components 410 and 411, first and second UPF components 412 and 413, a SIDNF 414, and first and second gNB components 415 and 416. The mobile network 400 is integrated with the SR-based transport network where, for example, each overlay node (e.g., NF component, WTRU or WTRU components within a WTRU, a host connected to a WTRU, a gNodeB component, a gateway, a SIDNF, and/or any SR node in a transport network etc.) may be configured with the one or more SID rules to process the one or more SIDs derived from (or equal to) the one or more MN-SIDs. The SR domain may, in some systems, be limited to the network side transport network only. In some other systems, the SR domain may (e.g., in “contiguous SR domain mode”) include one or more network elements in the network side of the air interface 405, and network elements in the WTRU side of the air interface 405. In some other systems (e.g., in “multiple SR domain mode”), one or more distinct SR domains may be configured, e.g., one on the network side of the air interface 405 (e.g., underlay for the core network nodes), and the one or more domains on the WTRU side of the network (e.g., ad hoc SR domains created between the one or more WTRUs interconnected over the side link, and/or the one or more SR domains in a home network and/or an enterprise network etc.).

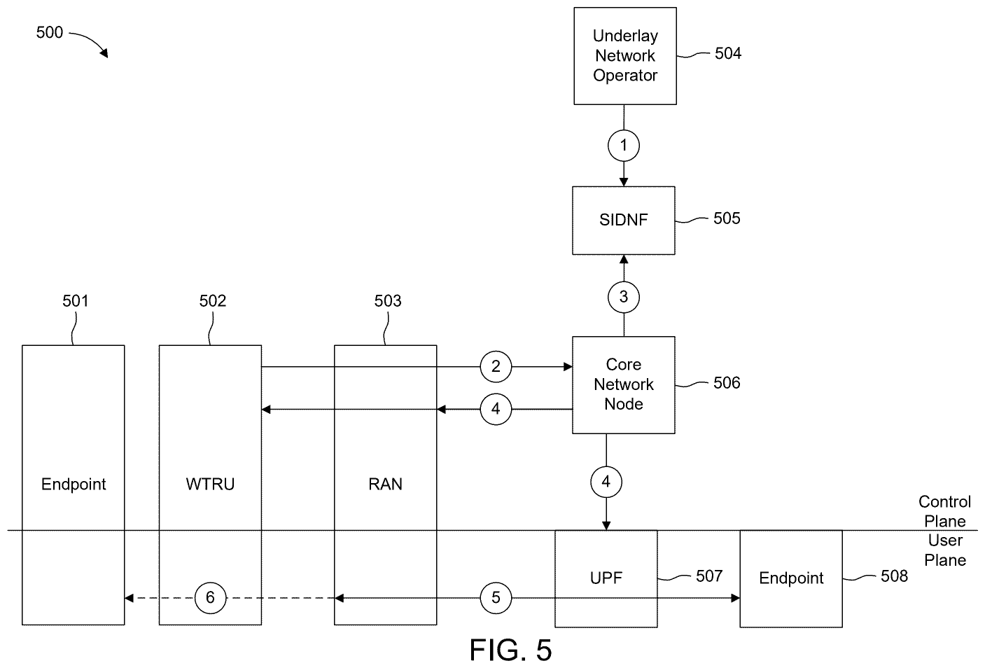

FIG. 5 illustrates one or more example phases in an SRBMN operation for the user plane traffic and/or the control plane traffic, according to one or more embodiments. FIG. 5 illustrates a first endpoint 501, a WTRU 502, a RAN node 503, an underlay network operator 504, a SIDNF 505, a core network 506, a UPF 507, and a second endpoint 508. The major phases involved in the operation of an SRBMN system for user plane traffic are depicted in FIG. 5. An order of the phases may in some systems be different.

In a first phase, a network operator configures the one or more MN-SIDs in the SIDNF and the one or more SID rules in the one or more network nodes. In an alternative, e.g., the network operator configures the one or more MN-SIDs and/or the one or more SID rules in the one or more network nodes.

In a second phase, the one or more SRBMN capabilities are exchanged.

In a third phase, the network determines the one or more MN-SIDs for the user and/or control plane paths. In some systems (as depicted in FIG. 5), the network node obtains the one or more MN-SIDs from the SIDNF, while in some other systems (not depicted in FIG. 5) the network node obtains the one or more MN-SIDs from a local configuration.

In a fourth phase, the network provides the one or more MN-SIDs to the one or more network nodes including the WTRU, the RAN node, and/or the CN nodes etc.

In a fifth phase, the one or more MN-SIDs (and/or the one or more SIDs derived from the one or more MN-SIDs) are used to steer the user and/or control plane traffic flows on the network side of the air interface. In some systems, the one or more MN-SIDs (and/or the one or more SIDs derived from the one or more MN-SIDs) are used to steer user and/or control plane traffic flows on both sides of the air interface.

The SRBM enables improving the architecture in various ways. The SRBMN enables an interface that interleaves (underlay) transport network services and the overlay mobile network services. The SBRMN uses the one or more SIDs to identify the one or more network services offered by the mobile network itself (e.g., the 5GLAN, the XR QoS handling, etc.). Consequently, the network services traditionally provided by the transport network, which may also be identified using the one or more SIDs, may be interleaved with the one or more network services traditionally provided by the mobile network.

When using the SRBMN, the granularity of the network services offered by the mobile network nodes may be smaller than in traditional (e.g., non-SRBMN) mobile networks, e.g., the gNodeB function may be split into multiple network services (e.g., including the XR QoS handling and/or the non-XR QoS handling, etc.), each identified using the one or more SIDs. In some systems, the granular network services may be stateless (e.g., if all necessary state can be transmitted in the SID and/or SR TLV associated with the packet). The statelessness enables the load balancing, and more generally high scalability. In exemplary systems where the traffic flows are transported over the stateless network functions identified by the one or more SIDs, there may be no need for one or more PDU session IDs and/or one or more S-NSSAI/slice IDs. In other exemplary systems where the traffic flows are transported over a mix of stateless and/or stateful network functions, the one or more IDs such as the one or more PDU session IDs and/or the one or more S-NSSAI/slice IDs may be used as the one or more arguments to some SIDs, to enable some network nodes to retrieve a state associated with the one or more IDs.

When using the SRBMN in a contiguous SR domain mode, the mobile network may control, in a unified manner, the one or more paths involving WTRU relays and/or involving various processing inside the WTRU, since the data packets sent over the air interface will in this case include the one or more SIDs. When using the SRBMN in multiple SR domains mode (with different SR domains on each side of the air interface), it may not be possible to not have the SR header on the data packets sent over the air interface, which is more efficient. There is therefore a trade-off, and it may be desirable to support both modes simultaneously and only use the contiguous SR domain mode when necessary. The SRv6 headers may be efficiently compressed over the air interface using ROHC.

The MN-SID is the SID that is configured into the mobile network and used by the mobile network to assemble (i.e. determine) the path for the user plane flow (e.g., the PDU session) or control plane flow (e.g., the control plane message of connection between the one or more control plane functions, or e.g., a NAS signaling connection). The one or more MN-SIDs identify segments include but are not limited to the node (e.g., the WTRU, the gNodeB, and/or the UPF etc.), an anycast set, an adjacency (e.g., on the WTRU, the adjacency may be the link to the gNodeB or the link to a ProSe relay), a prefix SID associated with a routing topology and/or an algorithm, a function associated with a standardized behavior, and/or the function associated with a behavior specific to the mobile network etc. In some cases, the MN-SID includes a locator which is generic (e.g., a generic locator may identify the gNodeB interconnected with the WTRU that is the subject of the MN-SID), while in other cases, the MN-SID includes the locator which is specific to the node (e.g., the gNodeB identifier that is unique within the network).

The mobile network provides the one or more MN-SIDs that describe the assembled path, to mobile network nodes (e.g., the RAN node, the WTRU, the UPF, and/or the core network nodes), which may insert the one or more MN-SIDs into the one or more PDUs, to program the assembled path into the user and/or control plane flow composed of the one or more PDUs. In some systems, the mobile network nodes first derive the one or more SIDs from the one or more MN-SIDs, and then insert the one or more derived SIDs into the one or more PDUs. In an example, the MN-SID may be a BSID, which may be transmitted by the mobile node to an SDN control, which translates the BSID into the list of SIDs and sends back the list of SIDs to the mobile node. In another example, the MN-SID may include the generic locator, and the mobile node may derive the SID by replacing the generic locator with a locator (e.g., locally configured) of the mobile node.

The SID rule is the IE used to configure the behavior for processing the SID. The SID rule includes the SID (e.g., the MN-SID), the behavior IE and may include the one or more additional parameters. The behavior IE identifies the processing of each matched packet (e.g., this may be a standardized behavior, or an operator-defined behavior). The one or more additional parameters may influence the processing. In an example, in a case where the behavior is to encapsulate the packet into a new IP header, the one or more additional parameters may include the list of SIDs to add in the SRH header of the new IP header and may in some cases also include the destination address for the new IP header. The SID rule may be conveyed using the control plane message (e.g., a PDU session establishment response, a PDU session modification command, an N4 message, a policy configuration message etc.) and/or a management plane message (e.g., a NETCONF message) etc.

The network operator (e.g., a management plane function of the underlay network operator) configures the one or more SIDs in the network and into the SIDNF. When configuring the one or more SIDs in the network, the operator configures the one or more nodes to process the one or more SIDs (e.g., the operator transmits the one or more SID rules to the node, and the node updates the corresponding FIB with an entry based on the SID and respective behavior and the one or more parameters). When configuring the one or more SIDs into the SIDNF, the operator associates the one or more SID with the one or more IEs that enable the identification of the one or more SIDs by the mobile network.

The SII provides information related to an (existing and/or on-request) segment. The one or more SIIs are associated with the one or more SID in the SIDNF. The one or more SIIs associated with the network path may be transmitted (e.g., by the SMF) to the SIDNF in the request message, to request the identifications of the segments (e.g., the one or more SIDs) of the network path.

A set of SIIs associated with the SID includes one or more of: location ID such as but not limited to an area ID and a tracking ID, a network slice ID, a S-NSSAI, the WTRU ID (e.g., the SUPI, the SUCI, the GUTI, the GPSI and/or the IMSI), a node type (e.g., the RAN, the WTRU and/or the UPF etc.), a link type (e.g., the side link, The WTRU-gNodeB, the WTRU to PIN element, the WTRU-WiFi AP, the Ethernet, and/or a fiber etc.), the one or more QoS characteristics (e.g., a latency, a maximum throughput, a packet loss ratio, a QoS identifier, a QCI, a ARP and/or a GBR etc.), the segment processing behavior (e.g., forwarding with an IP routing look up, an encapsulating in the IP header, the QoS handling, the XR QoS handling, the multi-access steering, the 5GLAN encapsulation and/or decapsulation etc.), a topology information (e.g., connectivity between nodes and related link type and link characteristics). The one or more SIIs may be associated with the one or more SIDs based on one or more characteristics of the node intended to process the one or more SID such as location (e.g., the area ID and/or the tracking ID), the network the slice (e.g. the S-NSSAI), the identification (e.g. the WTRU ID and/or the node type etc.); and/or the one or more characteristics of the one or more links connected to the node processing the one or more SID (e.g. the link type, the node type, the WTRU ID, the one or more QoS characteristics, and/or the topology information etc.); and/or a type of processing to perform for the one or more SIDs (i.e. the segment processing behavior). The generic and/or the partial MN-SID may be used to encode SII information. In an example, the generic MN-SID may include a locator portion that indicates a coarse location and/or a function portion that indicates the segment processing behavior.

The mobile network may configure some information in the SIDNF, e.g., to indicate when the new path becomes available (e.g., the new WTRU to WTRU side link connection becomes available and/or possible), or, e.g., to indicate when a mobility event occurs (e.g., the WTRU is now connected to the new gNodeB). The SIDNF may use the information to generate the new one or more MN-SIDs and/or the one or more SID rules. The one or more SID rules may be used by the underlay network operator to configure the network nodes. In some cases, the one or more SID rules may be provided to the mobile network operator node (e.g., the SMF and/or the AMF etc.), which may configure the one or more SID rules in the node.

The mobile network node (e.g., the SMF) may request a set of network services, corresponding to the list of SIDs, from the SIDNF. The mobile network node may determine the one or more SIIs associated with the network path such as but not limited to the location of the WTRU (e.g., the area ID and/or the tracking ID), a network slice requested by the WTRU (S-NSSAI), identification of nodes on the path (e.g. the WTRU ID, the node types, the one or more IDs of the one or more core network nodes involved), the requested QoS, available and/or preferred link types, available links and/or topology information (e.g., interconnections), the one or more requested network services for the service flow (e.g., the multi-access, the 5GLAN, the QoS handling, the XR QoS handling and/or the edge computing). The mobile network node may include the one or more SIIs in the request message transmitted to the to the SIDNF. The SIDNF may use the one or more SIIs to determine the one or more SIDs (e.g., the one or more MN-SIDs), and the SIDNF transmits the one or more determined MN-SIDs in the response message to the mobile network node. In some cases (e.g. pre-provisioned segments described hereinafter), the network operator may configure, ahead of time (e.g., ahead of the request from the SMF), the one or more SIDs and the one or more associated SIIs in the SIDNF. In some cases (e.g., on-request segments described hereinafter), the network operator receives the one or more SIIs from the SIDNF (e.g., based on the SIIs received from the SMF), determines the one or more SIDs corresponding to the one or more SIIs, and provides the corresponding one or more SIDs to the SIDNF.

Besides the one or more SIIs, the mobile network node may also provide arguments for the one or more SIDs (e.g., a 5GLAN ID that should be in the argument portion of the one or more MN-SIDs). The SIDNF may use the argument to match, along with the one or more SIIs, an existing SID. If a matching SID is not found, the SIDNF may provide the argument, along with the one or more SIIs, to the network operator, who may determine and/or generate the proper SID, configure the generated SID and the corresponding processing behavior in the network and provide the configured SID to the SIDNF, which may provide that SID back to the mobile network.

In some cases, the operator configures a segment (e.g. “pre-provisioned segment” identified by SID) into the SIDNF in advance of the usage in the mobile network. In an example, when provisioning the new node in the network (e.g., adding the SR router, the server, the gNodeB, and/or the UPF etc.), the operator may determine the one or more segments that should be implemented by the node, generate the SID and/or identify the existing SID for each segment, configure the SID (and the associated behavior, for example) in the network node and configure the SID (and the one or more associated SIIs, for example) in the SIDNF. The network operator may generate the one or more associated SIIs based on a new node identification, a type, a location, one or more capabilities (e.g., support for a feature such as but not limited to the XR QoS handling and/or the multi-access etc.), topology (e.g., one or more interconnections with other nodes).

In some cases, the operator configures the segment (“on-request segment” identified by the SID) into the SIDNF upon request by the mobile network. When the mobile network requests a set of segments to be provided by the SIDNF, the request message includes the set of SIIs, which the network operator uses to determine new and/or existing SIDs. The network operator programs the new SIDs into the one or more network nodes. In an example, the network operator determines, based on the one or more SIIs, that the XR QoS handling operation is needed in a certain location (e.g., based on the area ID). Based on this information, the network operator may locate the network node that is able to perform the operation at the proper location, generate the SID for the operation and configure the SID into the network node. Then, the network operator may provide the SID to the SIDNF, which may provide the SID to the mobile network.

In some cases, the SID configured by the operator into the SIDNF may be a binding SID, i.e., the SID may identify the SR policy. In an example, the mobile network node may request the set of network services from the SIDNF. The SIDNF may (or may trigger the network operator to) assemble (i.e. determine) the list of SIDs into the SR policy, create the binding SID for the policy, and/or configure the SR policy and/or the binding SID in the network. The SIDNF may transmit the binding SID to the mobile network node in the response message. Using the one or more SR policies may help limit the per-packet overhead since it limits the number of SIDs to insert in the packets.

In some cases, the SIDNF may register for and/or receive one or more events from other nodes (e.g., the PCF, the WTRU, the SMF, and/or the AMF etc.). The SIDNF may register for the one or more events that relate to all the WTRUs, and/or to all the PDU sessions. In an example, the purpose of the SIDNF registering to the one or more events includes maintaining the one or more network paths upon the WTRU relocation. Upon receiving the event, the SIDNF may configure the new SID, and/or the SIDNF may transmit one or more SID lists (e.g., the SID list updates) to other nodes such as but not limited to the SMF and/or the PCF. In an example, when receiving (e.g., from the AMF and/or the SMF) an event indicating that the WTRU relocates to the new gNodeB, the SIDNF may install the one or more new SIDs and/or identify the one or more existing SIDs that enable transmitting the PDU session traffic over the new path (e.g., through the new PSA UPF), and transmit to the SMF an updated MN-SID list for the PDU session. In another example, upon receiving an event indicating the new path is available (e.g., based on the WTRU detecting a neighbor second WTRU and indicating that the WTRU can forward traffic to and/or from the second WTRU), the SIDNF may transmit the indication to the SMF and/or the PCF, including the one or more SIIs (e.g., the ID of the second WTRU, the ID of the first WTRU, and/or one or more MN-SIDs of a portion of a path through the first WTRU to the second WTRU). Based on the indication, the SMF and/or the PCF may assemble the new path for the one or more PDU sessions and/or the one or more control plane paths involving the second WTRU and may transmit the updated (and/or modified) paths and/or segments to the mobile network nodes. In an example, the SMF and/or the PCF may trigger the PDU session update (and/or modification) to provide the updated segment lists.

In an embodiment, the SRBMN-capable mobile network may be deployed over the SR (e.g., the SRv6) capable transport network. The SRBMN-capable mobile network which supports the SR on the WTRU side of the air interface, in addition to the network side, may be referred to as the extended SRBMN-capable mobile network.

A heterogeneous SRBMN-capable mobile network may include one or more network elements which are not SRBMN-capable, e.g., one or more legacy network elements. To support heterogeneity, the one or more network elements such as but not limited to one or more CN nodes, one or more WTRUs, and/or one or more RAN nodes may expose the SRBMN capability indicator. The network node identifying the one or more user plane paths and/or the one or more control plane paths may determine to use the SRBMN or not, based on the one or more SRBMN capabilities of the network elements in the area.

In an example, the WTRU may include the SRBMN capability indicator in the PDU session establishment message and/or the modification message. If the WTRU is not SRBMN-capable, the SMF may determine to associate the one or more MN-SID lists with the PDU session, for the path between the RAN node and the PSA UPF. If the WTRU is SRBMN-capable, the SMF may determine to associate the one or more SID lists with the PDU session, for the whole path between the WTRU and the PSA UPF.

In another example, the WTRU may include the SRBMN capability indicator in the network registration message. If the WTRU is SRBMN-capable, the network (e.g., the AMF) may determine a first set of MN-SID lists (and/or a first set of MN-SIDs) for the uplink and a second set of MN-SID lists (and/or a second set of MN-SIDs) for the downlink, each list and/or each set of MN-SIDs defining the path for the control plane PDUs to and/or from the WTRU, and the network may transmit to the WTRU, the configuration message including the first and/or second MN-SID lists (and/or first and/or second sets of MN-SIDs). Based on the configuration message, the WTRU may insert the first and/or second set of MN-SID lists in the one or more control plane messages that the WTRU transmits in the uplink, and network nodes including the RAN nodes, the WTRUs, the core network nodes and the underlying transport network nodes process the SIDs to apply the one or more network services (e.g., including transmitting) to the messages to an intended recipient (e.g., the AMF and/or the or other core network nodes etc.). If the WTRU is not SRBMN-capable, the network may determine to use one or more legacy mechanisms for transmitting and/or receiving the one or more control plane messages to and/or from the WTRU. If the WTRU is SRBMN-capable, the one or more downlink control plane messages that are sent to the WTRU by the mobile network nodes include the one or more SID lists, and the one or more network nodes including the one or more RAN nodes, the one or more WTRUs, the one or more core network nodes and one or more underlying transport network nodes process the one or more SIDs to apply the one or more network services (e.g., including transmitting) to the one or more messages to their intended recipient (e.g., the WTRU). A SRBM-capable WTRU may further indicate (e.g., in a NAS-MM message) to the network (e.g., the AMF) that it is capable of routing the one or more control plane messages to and/from another WTRU (e.g. the second WTRU). In this case, the network may provide the second WTRU (e.g., in the registration response message) with the one or more SID lists for the transmission of the one or more control messages, including the SID implemented by the WTRU, and the network and the second WTRU may exchange the one or more control messages through the WTRU.

In an embodiment, methods and processes for determining the one or more MN-SIDs for the user and/or control plane path are provided.

A network node (e.g., the SMF and/or the AMF) determines the network path, including which of the one or more network services to apply on the path, upon receiving the request for the user plane resources (e.g., the PDU session establishment request) and/or the control plane resources (e.g., the network registration request). For this determination, the node may use the WTRU capabilities, the one or more network services requested by the WTRU, the WTRU connectivity information (e.g., which gNodeB the request is passing through), the WTRU location information (e.g., the tracking area and/or the cell ID), the capabilities of the network, and/or the subscription information etc. The determination may be based on the one or more existing methods to determine the user plane and/or control plane paths, e.g., including the identification of one or more mobile nodes included in the path (e.g., the WTRU, the RAN node, and/or the UPF etc.). However, in the SRBMN network, the network node may further decompose the set of network services into one or more sets of segments (e.g., the one set of segments for the DL and/or the one set of segments for the UL), where each segment provides a granular network service, e.g., forwarding, QoS handling, XR QoS handling, PDU set identification, multi-access steering, 5GLAN encapsulation, and/or local data network routing etc. In some systems, where multiple SR domains are used, there may be additional sets of segments, e.g., including a DL segment set and/or a UL segment set on the WTRU side of the air interface, and the DL segment set and/or the UL segment set on the network side. The network node may associate the one or more SIIs with each segment of each set. The network node may obtain the one or more MN-SID lists for each set from the SIDNF, using the one or more SIIs, as described above. In some systems not using the SIDNF, the network node may obtain the one or more MN-SID lists by synthetizing a generic MN-SID for each segment of each set, based on configuration.

In an embodiment, one or more methods and processes for providing the one or more MN-SIDs to the one or more network nodes are provided. The one or more MN-SIDs are both provided to the one or more mobile network nodes and programmed into the network. On one side, the one or more MN-SIDs need to be provided to the one or more mobile network nodes, to enable inserting the one or more MN-SIDs in the one or more packets. On the other side, the one or more SID rules corresponding to the one or more MN-SIDs need to be provided to the one or more network nodes on the path, to program the behaviors for processing the one or more SIDs (e.g., including the one or more mobile network nodes like the WTRU, the one or more RAN nodes and/or the one or more core network nodes, as well as one or more transport network nodes like one or more SR routers etc.).

The one or more mobile network nodes (e.g., the SMF, the PCF and/or the AMF etc.) that determine the network path provide the one or more MN-SIDs to the one or more appropriate mobile network nodes (e.g., the WTRU, the UPF, and/or the RAN nodes etc.). The one or more MN-SID lists are included in control plane messages such as the PDU session establishment response, the PDU session modification command, the network registration response and/or the policy configuration message. Each list of MN-SIDs may be provided along with (1) an implicit and/or explicit indication of respective direction, e.g., the UL and/or the DL, (2) a traffic filter to identify the packets (e.g., the one or more PDUs) to process, (3) an indication of the insertion operation, e.g., add the SRH header with the MN-SID list, and/or add the IP header with the SRH header with the MN-SID list. The traffic filters may be enhanced for one or more SRBMN operations, by adding a field for matching the SID. The URSP rules may be enhanced for the one or more SRBMN operations, by adding, in the traffic descriptor, an SID (e.g., to match incoming traffic with this SID), and by adding, in the route selection component, an SR entry which may include one SID, a list of SIDs and/or one SR policy (e.g., to indicate which SID to insert in the PDUs). The one or more N4 messages between the SMF and/or the UPF may be enhanced to include a traffic filter that may match the SID (e.g., to match incoming traffic with the SID), and to include an SR entry (e.g., for the DL traffic), which may include one SID, the list of SIDs and/or the SR policy (e.g., to indicate which SID to insert in the one or more PDUs).

The one or more SID rules corresponding to the one or more MN-SIDs are transmitted to the one or more network nodes, e.g., as described above, in relation to the SIDNF operation. In some cases, e.g., when the mobile network does not use the SIDNF, the network operator (e.g., an SDN controller) may transmit the one or more SID rules to the one or more network nodes, when the network resources are reserved (e.g., upon PDU session creation). In some cases, the one or more SID rules may also be transmitted by the mobile network node (e.g., the PCF, the SMF and/or the AMF etc.) to the one or more mobile network nodes: for example, the SMF may indicate in a policy rule (e.g., a QoS rule including the SID rule), that the WTRU may forward incoming traffic with a given SID to/from a certain QoS Flow. In an example, the PCF may indicate in a policy rule (e.g., a URSP rule containing the SID rule), that the WTRU may forward incoming traffic with a given SID to and/or from the one or more PDU sessions. In another example, the mobile network node may transmit the SID rule to the WTRU to configure a new side link (either connected and/or when a neighbor WTRU is in range). In yet another example, the WTRU may configure the SID rule when the neighbor WTRU is in range, and notifies the network (e.g., the SIDNF) that the new MN-SID is available.

In an embodiment, the methods and processes for inserting the one or more MN-SIDs in the one or more packets is provided. Upon receiving the one or more MN-SID lists (with the direction, the traffic filter and/or the insertion operation etc.), the mobile network node (e.g., the WTRU, the RAN node, and/or the UPF etc.) configures the one or more MN-ID lists for the data flow identified by the traffic filter, in the appropriate direction, and applies the insertion operation for each packet. In an example, the UPF may add an IP header to one or more DL packets, with the SRH header including the one or more MN-SID lists. The added IP header may be decapsulated in the RAN node and/or the WTRU node. In an example, the decapsulation operation is associated with the last MN-SID in the MN-SID list.

The RAN node may add the IP header to one or more UL packets received from the WTRU, with the SRH header including the MN-SID list. The added IP header may be decapsulated in the UPF.

In multiple SR domains mode, the WTRU may add the IP header to one or more DL packets received from the RAN node, with the SRH header including the MN-SID list. One of the MN-SIDs in the list may identify, e.g., the side link to another WTRU.

The WTRU may add the IP header to the one or more UL packets received from the WTRU application, with the SRH header including the MN-SID list. The MN-SID list may identify, e.g., the side link to another WTRU, and/or a connection to a specific gNodeB with a specific QoS handling etc.

For the traffic internal to the SR domain, e.g., a PMF protocol between the WTRU and the UPF, and/or the control plane traffic between the WTRU and the NF, or between two core network NFs, the sender (e.g., the WTRU and/or core network NF etc.) may insert the SRH header in the IP header of the PDU (e.g., without adding a new IP header) and transmit the packet.

In an embodiment, one or more new behaviors for the one or more MN-SIDs are provided. The one or more new behaviors are described hereinafter, to describe the one or more mobile network specific operations. The MN-SID may include a function code corresponding to the new behavior, as well as the one or more arguments. In some cases, some of the arguments may be included in other parts of the packet, e.g., in the TLV section of the SRH header. Using one or more MN-SID arguments may enable the processing of the one or more mobile network specific operations to be stateless in some cases. In other cases, the one or more arguments may be a key to retrieve the state associated with the processing. The stateless processing may enable a scalable design for the one or more network functions (e.g., the stateless processing may enable splitting a function such as the gNodeB and/or the UPF into microservices that are chained and/or load balanced).

In an embodiment, the methods and/or processes for new behavior for the QoS handling of the one or more PDU sessions are provided. The new MN-SID behavior End.QoSHandling may be defined for the QoS handling of the traffic flow. Typically, the End.QoSHandling may be implemented on the RAN node (for the DL) and/or the WTRU (for the UL). The one or more arguments associated with the End.QoSHandling may include one or more of: a PDU session ID, a QoS identifier code, a reflective QoS indication, a network slide ID (e.g., the S-NSSAI), a radio bearer type and/or ID etc.

When a node N receives a packet whose IPv6 DA is S and S is a local End.QoSHandling SID, the node N processes the packet through the End.QoSHandling behavior. In that, N forwards the packet over a radio bearer that is based on the arguments, e.g. indicated in the one or more arguments (e.g., using a read bearer ID), derived from the arguments (e.g., using the QoS identifier and/or reflective QoS indication), and/or derived from state information retrieved using the arguments (e.g., using the PDU session ID) etc.

In some systems, the End.QoSHandling must be the last segment in an SR policy, and in this case the End.QoSHandling behavior may remove an outer IPv6 header with all respective extension headers, prior to forwarding the packet.

In an example, the new behaviors for the XR QoS handling include a new MN-SID behavior End.PSQoSHandling is defined for a PDU set-based QoS handling of the traffic flow. Typically, the End.PSQoSHandling may be implemented on the RAN node (for the DL) and the WTRU (for the UL). The one or more arguments associated with the End.PSQoSHandling may include one or more of: the PDU set information, the burst information, the QoS information, charging related information etc.

The PDU set information may including one or more of: the PDU set importance, the PDU set sequence number, the packet sequence number within the PDU set, the PDU set start indication, the PDU set end indication, and/or the PDU set size etc.

The burst information includes one or more of: a burst size and/or an end of burst indication.

The QoS information includes one or more of: a PDU session ID, a QoS identifier code, a reflective QoS indication, and/or a radio bearer type or ID etc.

The charging related information may include an indication to pause and/or resume charging.

When the node N receives the packet whose IPv6 DA is S and S is the local End.PSQoSHandling SID, the node N processes the packet through the End.PSQoSHandling behavior. In that, the node N forwards the packet over the radio bearer that is based on the one or more arguments and applies the PDU set QoS handling using the PDU set and/or the burst information.

In some systems, the one or more IEs listed as the one or more arguments associated with the End.PSQoSHandling may be instead transmitted in the IP payload, e.g., in the UDP header extension and/or in a transport and/or application layer header.

In some systems, the End.PSQoSHandling must be the last segment in the SR policy, and in this case the End.PSQoSHandling behavior removes the outer IPv6 header with all the extension headers, prior to forwarding the packet.

The new MN-SID behavior (the End.PSIdentification) may be defined to identify the PDU set information, which is needed to enable the PDU set-based QoS handling of the traffic flow by the End.PSQoSHandling. Typically, the End.PSIdentification may be implemented on the UPF (for the DL) and the WTRU (for the UL). The one or more arguments associated with the End.PSIdentification may include a protocol ID and/or a flow ID. The protocol ID may identify the method of the PDU set identification. The flow ID may be the PDU session ID.

When the node N receives the packet whose IPv6 DA is S and S is a local End.PSIdentification SID, the node N processes the packet through the End.PSIdentification behavior. In that, the node N identifies the PDU set information for the packet, using the method based on the protocol ID (e.g., parsing an RTP header extension for the PDU set and/or parsing a UDP option including the PDU set information etc.). The node N may use the flow ID to retrieve some information such as the burst information.

The node N may search in the SRH header for the next SID with the behavior End.PSQoSHandling. If the SID is found, the node N writes in the SID (and/or the TLV portion of the SRH) the one or more arguments based on the information identified in the earlier step.

In an example, a new behavior for multi-access is provided. In that, a new MN-SID behavior H.MultiaccessSteering is provided for steering the multi-access traffic for the traffic flow. Typically, the H.MultiaccessSteering may be implemented on the UPF (for the DL) and the WTRU (for the UL). The one or more arguments associated with the H.MultiaccessSteering may include one or more of: a multi-access steering functionality, a multi-access steering mode and the one or more configuration IEs for the steering mode, the SR policy ID.

In an example, different behaviors may be defined for different steering functionalities and/or modes, in which case the steering functionalities and/or modes may not be needed as the argument. In one or more systems, the SR policy ID may be encoded in part of the SID prefix.

When the node N receives the packet whose IPv6 DA is S and S is a local H.MultiaccessSteering SID, the node N processes the packet through the H.MultiaccessSteering behavior. In that, the node N may forward the packet to a local multi-access steering NF, which may be identified by the steering functionality argument. The node N may provide the steering mode and/or the one or more configuration IEs for the steering mode, to the multi-access steering NF, along with the packet.

If using a low layer multi-access steering, the node N may encapsulate the packet in a new IP header including the SRH header with the SID list derived from the SR policy ID and the outcome of the multi-access steering NF. In an example, if the NF determines to use “link #2”, the node N may select a second SID list of an active candidate path of the SR policy identified by the SR policy ID.

If using a high layer multi-access steering (e.g., the MPQUIC and/or the MPTCP steering functionality), the node N encapsulates the one or more packets emitted by the multi-access steering NF based on the SR policy and the outer IP header of the emitted packet.

In an embodiment, the one or more new behaviors for the 5GLAN are provided. In that, new MN-SID behaviors H.5GLANEncap and H.5GLANDecap are provided for steering traffic through the 5GLAN. Typically, the H.5GLANEncap and the H.5GLANDecap may be implemented on the UPF and/or the WTRU. The one or more arguments associated with the H.5GLANEncap and the H.5GLANDecap may include one or more of: the 5GLAN ID, the source WTRU ID (e.g., the SUPI, the SUCI, the GUTI, the GPSI, and/or the IMSI etc.) and/or a hash value of the source WTRU ID.

When the node N receives the packet whose IPv6 DA is S and S is a local H.5GLANEncap SID, the node N processes the packet through the H.5GLANEncap behavior. In that, the node N may verify that the source WTRU is allowed on the 5GLAN, using the hash value of the source WTRU ID, and comparing with the hash values of the members of the 5GLAN (configured in the node N, and obtained by the node N from a local state using the 5GLAN ID).

The node N encapsulates the packet in a new IP header including the SID list configured in the node N, and obtained by the node N from the local state using the 5GLAN ID. In an example, the SID list may describe the path towards the UPF, and the last SID is the BSID on the UPF, which corresponds to the SR policy configured on the UPF, to reach the destination member of the 5GLAN.

When the node N receives the packet whose IPv6 DA is S and S is the local H.5GLANDecap SID, the node N processes the packet through the H.5GLANDecap behavior. In that, N may verify that the source WTRU is allowed on the 5GLAN. The node N removes the outer IPv6 header with all its extension headers, prior to forwarding the packet towards the destination 5GLAN member (using IPv4, IPv6 and/or Ethernet depending on the 5GLAN type etc.).

Using the SR to implement the 5GLAN enables, for example, including non-WTRUs in the 5GLAN (which may be reached using the SR policy or the IP route configured in the UPF. Using the SR to implement the 5GLAN provides the flexibility to combine multiple behaviors (e.g., the multi-access and/or the XR QoS handling etc.) on some portions of the 5GLAN and/or for some flows on the 5GLAN.

In an embodiment, a new behavior for local data network routing is provided. In that, a new MN-SID behavior End.LocalDataNetworkRouting is defined for steering the traffic flow. Typically, the End.LocalDataNetworkRouting may be implemented on the RAN node and/or intermediate the UPF. The one or more arguments associated with the End.LocalDataNetworkRouting may include: local data network name (DNN), non-local data network name, local DNN filter (e.g., regular expression and/or substring of a local DNN etc.).

When the node N receives the packet whose IPv6 DA is S and S is a local End.LocalDataNetworkRouting SID, the node N processes the packet through the End.LocalDataNetworkRouting behavior. In that, the node N determines if the local data network is accessible (using the local DNN and/or the local DNN filter provided in the argument, if any). In an example, “accessible” may mean that the RAN node is configured with the ID (e.g., the FQDN) of the PSA UPF that is local (e.g., collocated with the RAN node) and serves the data network (e.g., an LADN). Furthermore, for the PSA UPF to be “accessible”, the RAN node may further consider whether the PSA UPF is currently reachable over the IP network and/or the status connectivity with the PSA UPF (e.g., including congestion and/or packet loss considerations etc.).

If the matching local data network is accessible, the node N may forward the packet towards the local data network (e.g., route to the PSA UPF of the local DN).

If the matching local data network is not accessible, the node N may forward the packet towards the non-local data network (e.g., route to the PSA UPF of the non-local DN). The non-local DNN may be configured in the SR node and/or may be obtained from the non-local DNN argument.

In an embodiment, interfacing the mobile network with external networks using the one or more SIDs is provided. The one or more SIDs may be used to interconnect one or more flows originating from the external networks, with the SRBMN-capable mobile network. The packet entering the mobile network (e.g., at the UPF and/or at the WTRU etc.) may be identified as part of a specific interconnection, using the active SID that is agreed upon between the mobile network and an external entity (e.g., the application provider). The mobile network may add the SID to the packet leaving the mobile network (e.g., at the UPF and/or at the WTRU etc.) to enable the external network to identify the packet as part of a specific interconnection.

In an example, the AF transmits an “Nnef_AFsessionWithQoS” or “Npcf_PolicyAuthorization_Create” request message (or another request requesting a network service), enhanced to support SID-based interconnection, to the core network function (e.g., the NEF and/or the PCF). The request message includes a flow descriptor and an SID-based connection indicator (e.g., to request the SID-based interconnection to be used) and may include the one or more SIDs to use at the interconnection point. The mobile network sends the response to the AF, including the SID-based connection indicator (e.g., to indicate that SID-based interconnection will be used) and may include the one or more SIDs (e.g., generated by the mobile network) to use at the interconnection point. The core network configures the requested network services as usual (it may for example update the QoS parameters of an existing PDU session). The core network provisions the one or more SID rules in the mobile network ingress and/or egress points (e.g., at the PSA UPF and/or the WTRU). The provisioned SID rule includes the SID provided by in the request message, and/or the SID generated by the mobile network (e.g., by the SIDNF). A provisioned ingress SID rule may forward the traffic (with the matching active SID) through the PDU session corresponding to the requested network service. The provisioned egress SID rule forwards the traffic (with the matching active SID) from the PDU session corresponding to the requested network service. In an example, the egress SID rule may add the SID (obtained from the request) to the egress traffic, that ensures that the egress traffic is properly routed towards an application server.

In an embodiment, the SRBMN procedure for the user plane is provided.

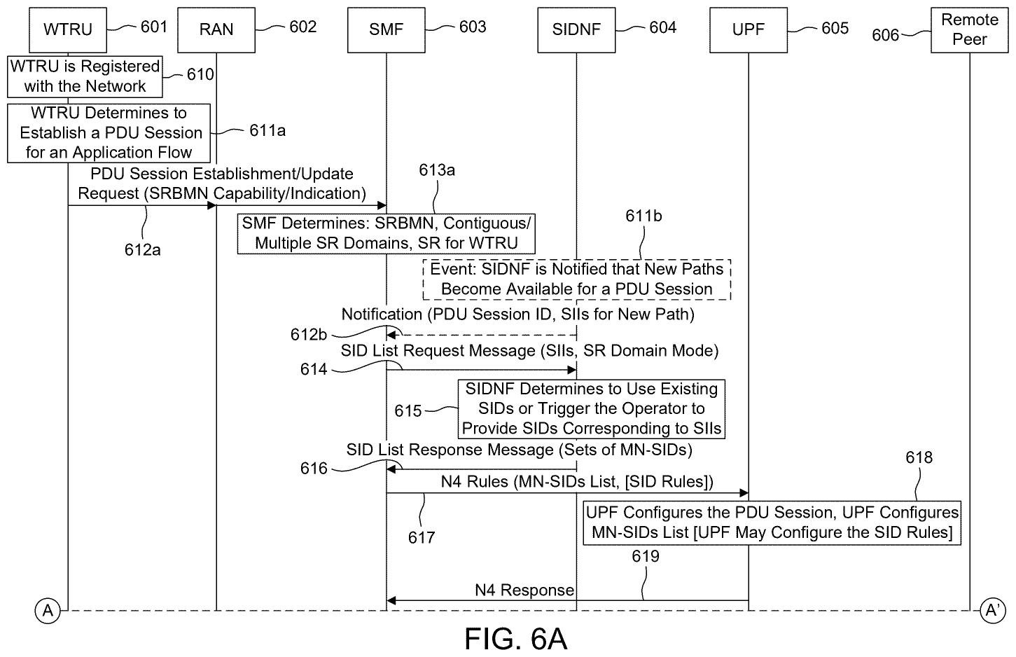

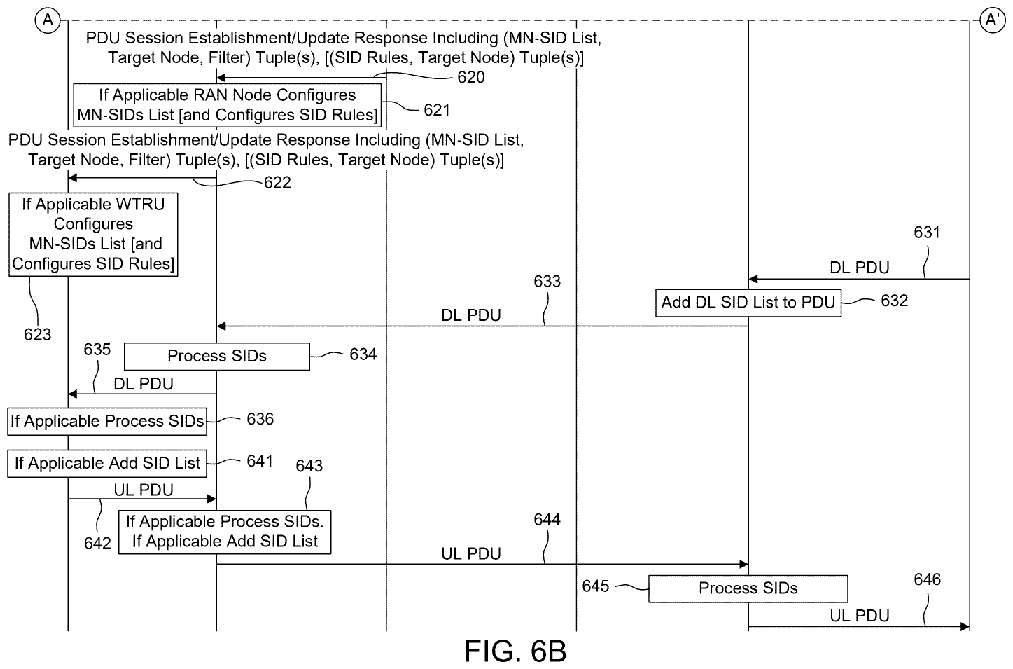

FIGS. 6A-6B illustrates an example method for the user plane session establishment in the SRBMN system, according to one or more embodiments. The method may be implemented between a WTRU 601, a RAN node 602, a SMF 603, a SIDNF 604, a UPF 605, and a remote peer device 606. The method describes an exemplary user plane session establishment in the SRBMN system. The SIDNF 604 may be configured as described above. Furthermore, the SIDNF 604 may register to the one or more events related to the existing PDU session, as described before. At 610, the WTRU 601 registers with the network. The procedure may be initiated by the WTRU 601 and/or by the SIDNF 604.

At 611a, the WTRU 601 determines to establish the PDU session for the application flow (e.g., to/from the WTRU application), e.g., based on the URSP rule.

At 612a, the WTRU 601 transmits the PDU session establishment and/or the modification request message. The WTRU 601 includes the SRBMN capability and/or indication in the request message, e.g., based on the WTRU capability and/or based on the SRBMN indication present in the URSP rule in 611a.

At 613a, the SMF 603 determines whether to apply the SRBMN (e.g., to use the one or more SIDs). The SMF 603 may determine whether to apply the SRBMN based on the indication that was received from the PCF that the SRBMN should be applied to the PDU session. The indication from the PCF may be received in a PCC rule. The SMF 603 may determine whether to apply the SRBMN based on the configuration that the SMF receives from the OAM system. In an example, the configuration information may indicate that the PDU session that is associated with certain DNN and/or the S-NSSAI combination should apply the SRBMN.

At 613a, the SMF 603 may further determine the “SR domain mode”, including whether to use contiguous and/or the multiple SR domains, and whether to use the one or more SR segments that include the WTRU 601.

At 611b, the SIDNF 604 receives the notification that one or more new paths are now available for the PDU session. In an example, the notification may be a mobility event notification from the AMF and/or the SMF 603, or the notification may be the notification (e.g., from a ProSe server) that the new path became available through a WTRU relay, and/or the notification may be a notification (e.g., from the PCF) that the policy rule was modified by the AF.

At 612b, the SIDNF determines a change of the number of SIIs associated with the PDU session and transmits, to the SMF 603, a notification message including the PDU session ID and the one or more SIIs.

At 614, the SMF 603 determines the one or more SIIs describing the network path, e.g., based on the PDU session establishment and/or the modification request, the WTRU location, the requested network slice (i.e. the S-NSSAI), identifications of the WTRU, the RAN node and/or the UPF, and/or the QoS characteristics from policy rules etc. The SMF may transmit the SID list request message which may include the one or more SIIs and may include the SR domain mode.

At 615, the SIDNF 604 determines the one or more SIDs (e.g., the one or more MN-SIDs) corresponding to the requested SIIs. The SIDNF 604 may use the one or more existing SIDs and/or trigger the creation of the one or more new SIDs by the network operator.

At 616, the SIDNF 604 transmits the SID list response message, including the one or more MN-SIDs. In an example, the one or more MN-SIDs may include one or more MN-specific SIDs described above.

At 617, the SMF 603 transmits the one or more N4 rules to the UPF 605, including the list of MN-SIDs to enable inserting the one or more MN-SIDs into the one or more PDUs.

In some cases, the one or more N4 rules include the one or more SID rules to enable configuring the one or more MN-SIDs and the respective behavior (e.g., in the UPF 605).

At 618, the UPF 605 configures itself to inserting the list of MN-SIDs into the one or more PDUs of the PDU session. If it received SID rules at 617, the UPF 605 configures the SID based on the one or more SID rules. In an example, the UPF 605 configures itself to process the one or more MN-SIDs (obtained from the SID rule) using the behavior obtained from the SID rule.

At 619, the UPF 605 transmits the N4 response message to the SMF 603, e.g., indicating success of the operation.

At 620, the SMF 603 transmits the PDU session establishment message and/or the modification response message including one or more tuples (e.g. the one or more MN-SID lists, the target node, and/or the traffic filter etc.). The response message may in some cases include the one or more tuples (e.g. the one or more SID rules and/or the target node etc.). The target node (e.g., the WTRU and/or the RAN node 602) may identify the node that should configure the MN-SID list and/or the SID rule. The traffic filter identifies the traffic that the MN-SID list should be applied to (e.g., the traffic filter may match “any traffic”, and/or match the UL and/or the DL direction, and/or match the IP addresses and ports etc.). The target node and/or the traffic filter may be implicit in some cases (e.g., there may be one list of the MN-SIDs for the UL traffic at the WTRU, and/or one list of the MN-SIDs for the UL traffic at the RAN node 602, and there may be one set of SID rules for the WTRU, and/or one set of SID rules for the RAN node 602 etc.). In cases where the procedure was triggered by an event (e.g., steps 611b and 612b were used), the messages at 620 and 622 may be a PDU session establishment message and/or a PDU session modification command message.

At 621, the RAN node 602 may configure itself to insert the one or more MN-SIDs into the one or more PDUs of the PDU session (e.g., for the uplink PDUs in cases where the RAN node 602 is the edge of the SR domain). The RAN node 602 may use the target nodes (associated with MN-SID lists) to identify the one or more MN-SID lists applicable to configure on the RAN node 602. The RAN node 602 may use the traffic filter to identify the one or more PDUs of the PDU session. The RAN node 602 may configure itself to process the MN-SID (obtained from the SID rule associated with the RAN node, if any) using the behavior obtained from the SID rule associated with the RAN node. The RAN node 602 may use the target nodes (associated with SID rules) to identify the one or more SID rules to configure on the RAN node 602.

At 622, the RAN node 602 forwards the response message towards the WTRU 601.

At 623, the WTRU 601 may configure itself to insert the one or more MN-SIDs into the one or more PDUs of the PDU session (e.g., the one or more uplink PDUs in cases where the WTRU 601 is in the same SR domain as the RAN node 602. In an example, the one or more downlink PDUs in cases where the WTRU 601 is the edge of a WTRU-side SR domain and where the WTRU 601 is acting as a relay for the one or more PDUs). The WTRU 601 may configure itself to process the MN-SID (obtained from the SID rule associated with the WTRU 601, if any) using the behavior obtained from the SID rule associated with the WTRU 601. The WTRU 601 may use the target nodes (associated with the one or more MN-SID lists) to identify the one or more MN-SID lists applicable to configure on the WTRU 601. The WTRU 601 may use the traffic filter to identify the one or more PDUs of the PDU session. The WTRU 601 may use the target nodes (associated with the one or more SID rules) to identify the one or more SID rules to configure on the WTRU 601.

In 631-636, the forwarding of the DL PDU over the PDU session is described.

At 631, the remote peer 606 transmits the DL PDU towards the WTRU application, through the UPF 605.

At 632, the UPF 605 determines that the DL PDU matches the traffic filters associated with the PDU session. The UPF 605 inserts the one or more MN-SIDs (e.g., configured for this PDU session at 618) into the PDU. In an example, the UPF 605 inserts the new IP header in the PDU, including the SRH including the MN-SID list. Although not shown, some MN-SIDs in the MN-SID list may be processed in the UPF 605 (e.g., the PDU set identification).

At 633, the UPF 605 forwards the DL PDU towards the RAN node 602.

At 634, the RAN node 602 may process the one or more MN-SIDs in the MN-SID list in the PDU (e.g., the XR QoS handling).

At 635, the RAN node 602 forwards the DL PDU towards the WTRU 601.

At 636, the WTRU 601 may process the one or more MN-SIDs in the MN-SID list in the PDU (e.g., forwarding towards another WTRU if the WTRU 601 is acting as the relay). The PDU may be forwarded towards the destination (e.g., the WTRU application on the WTRU, on a device attached to the WTRU, and/or one another WTRUs using this WTRU as the relay).

In 641-646, the forwarding of the UL PDU over the PDU session is described.

At 641, the WTRU application transmits the UL PDU towards the remote peer 606. The WTRU 601 may insert the one or more MN-SIDs (e.g., configured for the PDU session) in the one or more PDUs. Although not shown, the one or more MN-SIDs in the MN-SID list may be processed in the WTRU 601 (e.g., multi-access).

At 642, the WTRU 601 transmits the UL PDU towards the RAN node 602.

At 643, the RAN node 602 may process the one or more MN-SIDs in the MN-SID list in the PDU (e.g., forwarding towards the UPF 605). In some cases, the RAN node 602 may insert the one or more MN-SIDs (e.g., configured for this PDU session in at 621) into the PDU.

At 644, the RAN node 602 forwards the UL PDU to the UPF 605.

At 645, the UPF 605 may process the one or more MN-SIDs in the MN-SID list in the PDU (e.g., 5GLAN behavior).

While a single UPF is described in the figure, in some cases, one or more intermediate UPFs may be on the path of the traffic (e.g., acting as uplink classifier or branching point).

At 246, the UPF 605 may decapsulate the outer IP header (including the SRH) and forward the PDU to the remote peer 606.

In an embodiment, the SRBMN procedure for the control plane is provided.

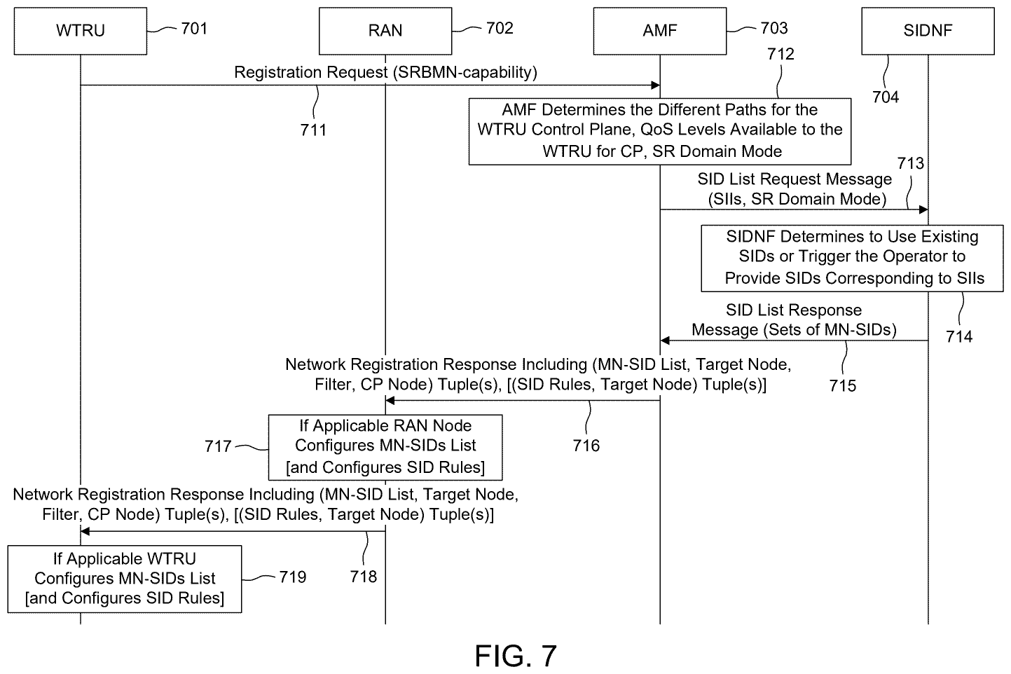

FIG. 7 illustrates an example method of the WTRU control plane session establishment in the SRBMN system, according to one or more embodiments. The method may be implemented between a WTRU 701, a RAN node 702, an AMF 703, and an SIDNF 704. The method describes an exemplary WTRU control plane session establishment in the SRBMN system. The SIDNF 704 may be configured as described above.

At 711, the WTRU 701 transmits the registration request message to the network (e.g., the AMF 703 through the RAN node 702). The WTRU 701 may include the SRBMN capability and/or the indication in the request message, e.g., based on the WTRU 701 capability.

At 712, the AMF 703 determines whether to apply the SRBMN (e.g., to use the one or more SIDs). The AMF 703 may determine whether to apply the SRBMN based on configuration that is received from the OAM system. The AMF 703 may determine how to configure the SRBMN feature based on WTRU subscription information. In an example, the subscription information of the WTRU 701 may indicate that the control plane traffic that is associated with the WTRU 701 should receive high priority and/or low priority traffic. The AMF 703 determines the different paths for the WTRU control plane messages, and the AMF 703 determines the QoS levels available to the WTRU 701. The AMF 703 determines the “SR domain mode”, including whether to use contiguous and/or multiple SR domains, and whether to use SR segments that include the WTRU 701.

At 713, the AMF 703 determines the one or more SIIs describing the network paths, e.g., based on the WTRU location, available and/or requested network slices (S-NSSAI), identifications of the WTRU, RAN node, the one or more QoS characteristics (e.g., from new policy rules describing QoS for CP, and possibly associated with the WTRU subscription). The AMF 703 transmits the SID list request message which includes the one or more SIIs and may include the SR domain mode.

At 714, the SIDNF 704 determines the one or more SIDs (e.g., the one or more MN-SIDs) corresponding to the one or more requested SIIs. The SIDNF 704 may use the one or more existing SIDs and/or trigger the creation of the one or more new SIDs by the network operator.

At 715, the SIDNF 704 may transmit the SID list response message, including the one or more MN-SIDs. In an example, the one or more MN-SIDs may include the one or more MN-specific SIDs.

The process in 716, 717, 718, and 719 is similar to the process in 620, 621, 622, and 623, with the following adaptation: instead of applying to the specific PDU session, the one or more MN-SID lists and the one or more SID rules may apply to control the traffic between the WTRU 701 and one or more control plane nodes. The tuples may include an additional IE, that identifies the control plane node. In an example, the MN-SID list, the target node, the traffic filter, and/or the CP node etc. instructs the target node, e.g., the WTRU 701 or the RAN node 702, to insert the one or more MN-SID lists into the one or more PDUs matching the traffic filter and directed towards the CP node (e.g., the AMF and/or the SMF and/or any other CP node etc.).

The operation of UL and/or DL control messages between the WTRU 701 and the network nodes (e.g., the AMF and/or the SMF etc.) is similar to 631-635 and 641-646 described above, with the following adaptations: (1) replacing the UPF with the network node such as the AMF and/or the SMF etc., and (2) the network node is the endpoint, i.e., the network node forwards traffic to/from a software program running on the network node, and there is no external remote peer.

For control plane traffic between the core network functions (e.g., between any two of the AMF, the SMF, the PCF, the UPF and/or other NFs etc.), the network operator may configure the one or more SIDs in the transport network, using the management plane (e.g., using the NETCONF protocol). If the NFs are SR-aware, they may directly transmit traffic including the one or more SIDs. In another example, the NFs may transmit traffic towards the destination NF, using the SID as the destination IP address (e.g., an IPv6 address learned from the DNS system).

In an embodiment, the SRBMN procedure for the edge computing is provided.

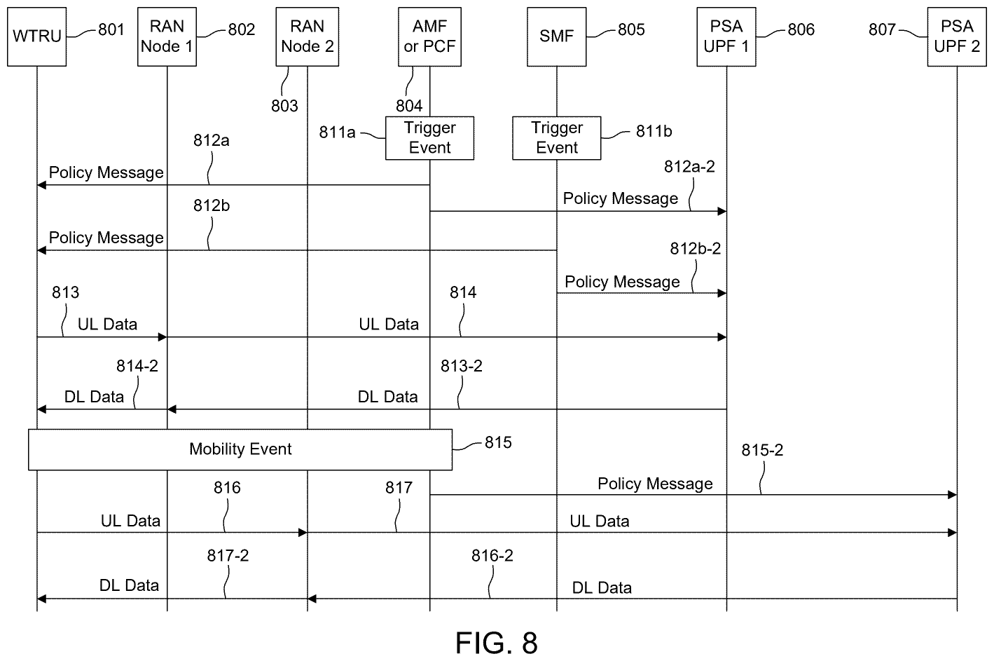

FIG. 8 illustrates an example process of the SRBMN procedure for the edge computing, according to one or more embodiments. The process is illustrative of the operation, within the SRBMN of the mobile network function configured to process the MN-SID. The process may be performed between a WTRU 801, a first RAN node 802, a second RAN node 803, an AMF and/or PCF 804, an SMF 805, a first PSA UPF 806 and a second PSA UPF 807.

FIG. 8 describes the operation of the RAN nodes processing the MN-SID with the behavior End.LocalDataNetworkRouting (e.g., the function part of the SID contains a code corresponding to End.LocalDataNetworkRouting). Other procedures may be derived from FIG. 8, where the one or more nodes (e.g., the WTRU, the RAN node, the UPF, and/or the underlying transport network node) processes the one or more MN-SIDs with behaviors such as but not limited to End.QoSHandling, End.PSQoSHandling, End.PSIdentification, H.MultiaccessSteering, H.5GLANEncap, H.5GLANDecap and/or End.LocalDataNetworkRouting etc.

Furthermore, the procedure described in FIG. 8 is illustrative of the mode of operation where the one or more MN-SIDs are installed prior to the flow establishment (e.g., the PDU session establishment and/or the control plane flow establishment etc.). For example, once the WTRU 801 registers with the network, the network may install the SR-specific policy rules (named the one or more MN-SID label application policies herein and described hereinafter) in the WTRU 801 and the first and second PSA UPFs 806 and 807, to enable the UP traffic to be exchanged without requiring the PDU session establishment procedure.

In an example, the session breakout model may be used as a connectivity model for edge computing, the SMF is required to track the location of the WTRU 801 and monitor the WTRU application layer traffic so that the SMF 805 may make decisions about adding PSA anchors and configuring branching points for the WTRU PDU session.

FIG. 8 shows an example procedure where the WTRU 801 may be configured with policy information and the WTRU 801 may use the policy information to apply the one or more MN-SIDs to the uplink traffic so that the RAN, the core network and the underlying network nodes may use the one or more MN-SIDs to route the uplink traffic to the appropriate PSA UPF (in the following example, a single RAN node is considered, however more generally one or more RAN, core network and underlying network nodes may be involved in routing traffic to/from the PSA UPF etc.). In an example, the WTRU 801 may apply the one or more MN-SIDs to certain traffic. The first RAN node 802 may use the MN-SIDs to determine to route the traffic to a central (e.g., non-edge) PSA UPF because the first RAN node is not able to access an edge data network that hosts services that are related to the application traffic. Whereas a second RAN node 803 may use the same one or more MN-SIDs to determine to route the traffic to a local PSA UPF because the second RAN node 803 is able to access the edge data network that hosts services that are related to the application traffic. In other words, the local UPF may be used to reach the edge data network that hosts services that are related to the application traffic.

The policy information that is configured in the WTRU 801 may be referred to as the one or more MN-SID label application policies. Each MN-SID label application policy may include two parts. The first part of the policy is a traffic detection part. The traffic detection part may be used to identify the traffic that the policy applies to. The traffic detection part may include the destination IP address and/or a port number, may include an application type, a connection type identifier, an application descriptor, an SID, and/or a domain name etc. The second part of the policy is a label. The label is the one or more MN-SIDs that should be added to the header of any traffic that the matches the traffic detection part of the policy. In another example, the label may enable obtaining the one or more MN-SIDs (e.g., the label may be the BSID that corresponds to a policy including the one or more MN-SIDs).

The one or more MN-SID label application policies may also be configured in the one or more UPFs, to enable the DL traffic to be routed towards the WTRU 801, without requiring the PDU session establishment procedure and/or modification procedure for each application flow. The one or more MN-SID label application policies may be installed on the one or more UPFs that are usable for different types of applications (e.g., on one or more central UPFs and/or local UPFs), based on the location of the WTRU 801. The network may add and/or remove the one or more MN-SID label application policies to and/or from the one or more UPFs based on the location of the WTRU 801 (e.g., add the one or more policies to a new central UPF when the WTRU 801 enters a service area that is handled by this central UPF).

A benefit of the procedure of FIG. 8 is that the SMF 805 does not need to re-configure classifier and/or branching point UPFs when the WTRU 801 mobility events take place. Rather, the WTRU 801 may be configured in advance to apply a label to any traffic that matches a criteria and the RAN node may use the label to determine to route the traffic to the edge data network if the edge data network is accessible and/or the RAN node may be configured to route the traffic to the central UPF regardless of the label (i.e. because the edge data network is not accessible to the RAN node). In an example, an exemplary End.LocalDataNetworkRouting behavior is described above, that corresponds to this processing.

In an example, the network operator may configure the one or more MN-SIDs in the one or more network nodes, e.g., in the first RAN node 802 and the second RAN node 803.

At 811a, the AMF and/or PCF 804 detects the triggering event and detection of the triggering event causes the AMF and/or PCF 804 to determine to transmit the one or more MN-SID label application policies to the WTRU 801. The triggering event may be the reception of the new policy information from the UDM. The triggering event may be based on detecting that the WTRU 801 is performing the registration procedure.

If the WTRU 801 receives the one or more MN-SID label application policies in a NAS-MM message, then the WTRU 801 may apply the policy to all uplink traffic.

In step 811b, the SMF 805 detects the triggering event and detection of the triggering event causes the SMF 805 to determine to send one or more MN-SID label application policies to the WTRU 801. The triggering event may be reception of policy information from the AMF and/or PCF 804. The triggering event may be the notification that is received from the UPF that indicates that the WTRU 801 is running a type of application and/or sending traffic to a specific IP address. In other words, the triggering event may be reception of a notification that provides information about the characteristics of the WTRU 801 traffic in the PDU session.

If the WTRU 801 receives the one or more MN-SID label application policies in the NAS-SM message, then the message may also include the PDU session ID and then the WTRU 801 may apply the policy to all uplink traffic of the PDU session.

The processes in 811a, 812a, 812a-2 and 811b, 812b, and 812b-2 may be alternatives.

At 812a, the AMF and/or PCF 804 transits the one or more MN-SID label application policies to the WTRU 801 in the NAS-MM message.

At 812a-2, the AMF and/or PCF 804 determines the one or more UPFs that may be used for traffic to and/or from the WTRU 801. The AMF and/or PCF 804 transmits the one or more MN-SID label application policies to the one or more UPFs, using the CP message direct and/or indirect, e.g., through the SMF 805 and/or SIDNF and/or PCF.

At 812b, the SMF 805 sends the one or more MN-SID label application policies to the WTRU 801 in a NAS-SM message.

at 812b-2, the SMF 805 determines the one or more UPFs that may be used for traffic to and/or from the WTRU 801. The SMF 805 transmits the one or more MN-SID label application policies to the one or more UPFs, using the CP message direct (e.g., the one or more N4 session messages) and/or indirect, e.g., through the SIDNF and/or the PCF.

At 813, the WTRU 801 determines to transit the PDU in the uplink. Before sending the UL PDU, the WTRU 801 detects that the characteristics of the PDU match the traffic detection part of the one or more MN-SID label application policies. Based on the PDU matching the traffic detection part of the one or more MN-SID label application policies, the WTRU 801 adds the one or more MN-SIDs from the label part of the policy to the PDU. The WTRU 801 then sends the UL data packet to the network. The UL data packet includes the PDU that was received from the WTRU application and the appended one or more MN-SIDs.

If the WTRU 801 receives the one or more MN-SID label application policies in the NAS-MM message, the WTRU 801 may apply the label to the traffic and then evaluate URSP rules to determine what PDU session to use to send the traffic. The URSP rules may be enhanced so that the traffic descriptor may be a label, thus the applied label may be used to select the PDU session to send the traffic.

If the WTRU 801 receives the one or more MN-SID label application policy in the NAS-SM message, the WTRU 801 may receive the PDU from an application, evaluate URSP rules to determine what PDU session to use to send traffic, and then use the one or more MN-SID label application policy to determine what label to apply to the uplink traffic.

The URSP rules may be used to select the PDU session. The one or more MN-SID label application policies may be used to determine what label to apply to the traffic.

At 814, the first RAN node 802, receives the UL data. The first RAN node 802 may determine that the one or more MN-SIDs indicate that the traffic should be routed to the certain type of edge data network and/or a certain type of edge data service if the type of edge data network and/or type of edge data service is accessible. In an example, the active MN-SID may correspond to a new SR behavior “local data network” described herein. In this example, the first RAN node 802 may determine that no edge data network and/or edge data services are accessible and therefore the data should be routed to the first PSA UPF 806.

In this example, the first PSA UPF 806 may be the central PSA UPF.

At 813-2, the UPF receives the DL PDU in the downlink. Before forwarding the DL PDU, the UPF detects that the characteristics of the PDU match the traffic detection part of the one or more MN-SID label application policies. Based on the PDU matching the traffic detection part of the one or more MN-SID label application policies, the UPF adds the one or more MN-SIDs from the label part of the policy to the PDU. The UPF then sends the DL data packet to the network. The DL data packet includes the PDU that was received and the one or more appended MN-SIDs.

At 814-2, the first RAN node 802 receives the DL data. The first RAN node 802 may process the one or more MN-SIDs that are implemented on the first RAN node 802 (e.g., the QoS handling). The first RAN node 802 forwards the PDU towards the WTRU 801.

At 815, a handover event and/or a cell re-selection event may occur. The result of the event may be that the WTRU 801 point of attachment to the network changes. In other words, the WTRU 801 attaches to the network via a different RAN node. In an example, the different RAN node may be the second RAN node 803.

At 815-2, the event is detected by the CP node such as the AMF and/or PCF 804 of the SMF 805. The CP node may identify that the first PSA UPF 806 should change to the second PSA UPF 807, and in such case the CP node assembles (i.e. determines) the one or more MN-SID label application policy that enables forwarding the DL traffic (and applying appropriate services such as QoS) towards the WTRU 801 through the second RAN node 803. The CP node transmits the assembled (i.e. determined) one or more MN-SID Label application policies to the second PSA UPF 807.

At 816, the WTRU 801 determines to transmit the PDU in the uplink. In this example, the PDU of this step is similar to the PDU of 813. The PDU of this step and 813 are similar in the sense that they come from the same WTRU application, come from the same type of application, and/or are sent to the same IP address and/or the port number. Before sending the UL PDU, the WTRU 801 detects that the characteristics of the PDU match the traffic detection part of the MN-SID label application policies. Since the PDU of 816 is similar to the PDU of 813, the WTRU 801 will detect that the PDU of 813 matches the same policy that was detected in 813. Based on the PDU matching, the traffic detection part of the one or more MN-SID label application policies, the WTRU 801 adds the one or more MN-SIDs from the label part of the policy to the PDU. The WTRU 801 then transmits the UL data to the network. The UL data is the PDU that was received from the WTRU application and the one or more appended MN-SIDs. The one or more MN-SIDs that are appended in this step may be the same as the one or more MN-SIDs that were appended in step 813.

At 817, the second RAN node 803 receives the UL data. The second RAN node 803 may determine that the one or more MN-SIDs indicate that the traffic should be routed to a certain type of edge data network or a certain type of edge data service if the type of the edge data network and/or type of the edge data service is accessible. In this example, second RAN node 803 may determine that the edge data network and/or the edge data services that are of the certain type are accessible. Therefore, the second RAN node 803 may determine to route the traffic to the second PSA UPF 807. In this example, the second PSA UPF 807 may be the local PSA UPF and may be used to route traffic to the edge data network and one or more edge data services.

At 816-2, the second PSA UPF 807 receives the DL PDU in the downlink. Before forwarding the DL PDU, the PSA UPF 807 may detect that the characteristics of the PDU match the traffic detection part of the one or more MN-SID label application policies. Based on the PDU matching, the traffic detection part of the MN-SID label application policies, the UPF may insert the one or more MN-SIDs from the label part of the policy in the PDU. The UPF then transmits the DL data packet to the network. The DL data packet includes the PDU that was received and the one or more appended MN-SIDs.

At 817-2, the second RAN node 803, receives the DL data. The second RAN node 803 may process the one or more MN-SIDs that are implemented on the second RAN node 803 (e.g., the QoS handling). The second RAN node 803 forwards the PDU towards the WTRU 801.

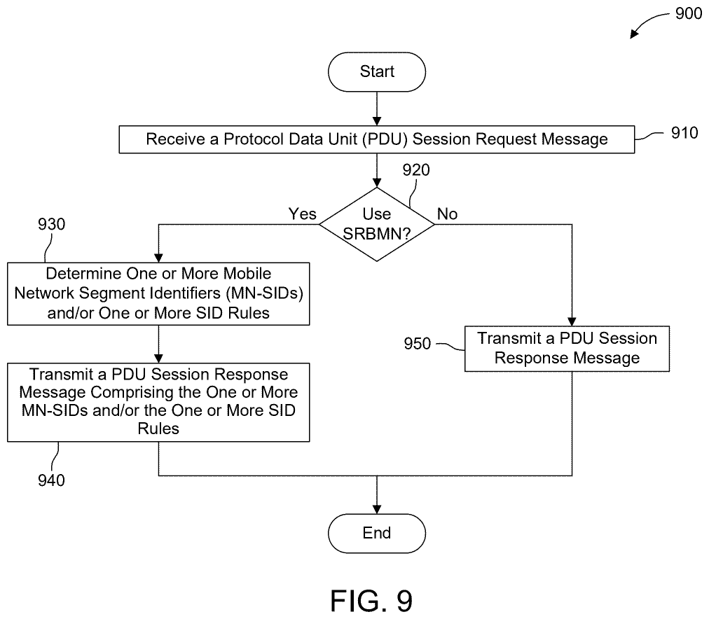

FIG. 9 illustrates an example process 900 performed by a core network node, according to one or more embodiments. The process 900 may be performed by the SMF. At 910, the node receives a PDU session request message. In an example, the PDU session request message may be the PDU session establishment request and/or the PDU session modification request. The PDU session request may be one or more of: the network registration request, the trigger indicative of the new policy information, the mobility event, and/or the notification of availability of the new path etc., for example.

At 920, the node determines whether to use SRBMN based on the one or more SRBMN capabilities or the indication of enablement of the SRBMN in the PDU session request message. The node also determines the extent of the SR domain (e.g., whether the SR domain includes the WTRU). The node also determines the one or more SIIs that describe the SR path (and/or the network path, for example). The SR path may include one or more types of segments and/or operations (e.g. the network operations) etc. The node determines the one or more MN-SIDs. The node may also determine the one or more SID rules. In that, the node may transmit to the SIDNF, the SID request message including the one or more SIIs and possibly including the indication of the extent of the SR domain (e.g., whether the SR domain includes the WTRU). The node receives, from the SIDNF, the one or more MN-SIDs and/or the one or more SID rules, defining the network path and/or the network operations for the network service.

At 930, if the SRBMN is used, the node determines the one or more MN-SIDs and/or the one or more SID rules.

At 940, the node transmits a PDU session response message comprising the one or more MN-SIDs and/or the one or more SID rules.

At 950, if the SRBMN is not used, the node transmits the PDU session response message.

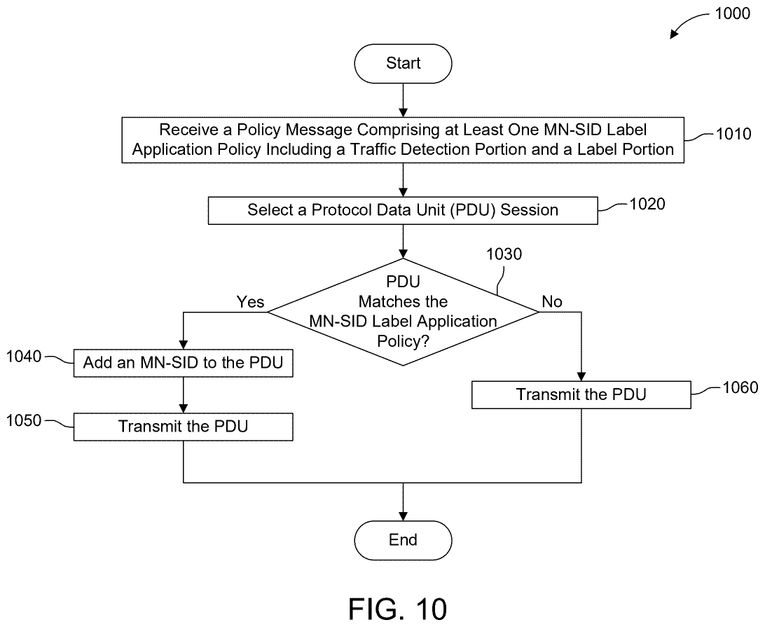

FIG. 10 illustrates an example process 1000 performed by the WTRU, according to one or more embodiments. At 1010, the WTRU receives the policy message comprising at least one MN-SID label application policy including the traffic detection portion and the label portion.

At 1020, the WTRU selects the PDU session. In that, the WTRU detects at least one traffic characteristic of the one or more PDU sessions. The WTRU evaluates at least one URSP comprising the traffic descriptor. The WTRU selects the PDU session of the one or more PDU sessions having the traffic characteristic that matches the traffic descriptor.

At 1030, the WTRU checks whether the PDU matches the MN-SID label application policy.

At 1040, if the PDU matches the MN-SID label application policy, the WTRU inserts the at least one MN-SID in the PDU.

At 1050, the WTRU transmits the PDU. The WTRU inserts the at least one MN-SID in each PDU associated with the PDU session. The WTRU transmits the each PDU to the first RAN node. In case of change the point of attachment to the mobile network, the WTRU transmits the PDU and one or more successive PDUs to the second RAN node.

At 1060, if the PDU does not match the MN-SID label application policy, the WTRU transmits the PDU.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method performed by a core network (CN) node, the method comprising:
receiving a request message;
on a condition that the request message is indicative of one or more segment routing (SR) based mobile networking capabilities,
determining use of an SR based mobile network (SRBMN);
determining at least one of: one or more mobile network segment identifiers (MN-SIDs) or one or more SID rules; and
transmitting a response message comprising at least one of: the one or more MN-SIDs or the one or more SID rules.

2. The method of claim 1, wherein the request message is indicative of at least one of: a protocol data unit (PDU) session establishment request, a PDU session modification request, or a network registration request.

3. The method of claim 1, wherein the response message is indicative of at least one of: a PDU session establishment response, a PDU session modification command, a PDU session modification response, a network registration response, or a notification message.

4. The method of claim 1, wherein the request message is associated with a wireless transmit/receive unit, and wherein the request message is received from a radio access network (RAN) node, and wherein the response message is transmitted to the RAN node.

5. The method of claim 1, wherein determining at least one of: the one or more MN-SIDs or the one or more SID rules comprises:
determining an SR path based on the request message; and
determining one or more segment identification information elements (SIIs) associated with the SR path.

6. The method of claim 5, further comprising:
transmitting, to an SID network function (SIDNF), an SID request message indicative of the one or more SIIs; and
receiving, from the SIDNF, an SID response message indicative of at least one of:
the one or more MN-SIDs or the one or more SID rules.

7. The method of claim 6, further comprising:
receiving a notification indicative of a change in the one or more SIIs;
generating an updated SID request message based on the change in the one or more SIIs; and
transmitting the updated SID request message to the SIDNF.

8. The method of claim 1, wherein the one or more SID rules include:
the one or more MN-SIDs,
a behavior information element (IE) indicative of a function for processing the one or more MN-SIDs, and
one or more arguments associated with the function.

9. The method of claim 1, wherein determining use of the SRBMN comprises:
receiving one or more policies from a policy control function (PCF); and
determining the use of the SRBMN based on at least one policy of the one or more policies.

10. The method of claim 1, wherein the CN node is a session management function (SMF) node.

11. A core network (CN) node, comprising:
a memory;
a transceiver; and
a processor, wherein the transceiver and the processor are configured to:
receive a request message,
on a condition that the request message is indicative of one or more segment routing (SR) based mobile networking capabilities,
determine use of an SR based mobile network (SRBMN),
determine at least one of: one or more mobile network segment identifiers (MN-SIDs) or one or more SID rules, and
transmit a response message comprising at least one of: the one or more MN-SIDs or the one or more SID rules.

12. The CN node of claim 11, wherein determining at least one of: the one or more MN-SIDs or the one or more SID rules comprises:
determining an SR path based on the request message, and
determining one or more segment identification information elements (SIIs) associated with the SR path.

13. The CN node of claim 12, wherein the transceiver and the processor are further configured to:
transmit, to an SID network function (SIDNF), an SID request message indicative of the one or more SIIs, and
receive, from the SIDNF, an SID response message indicative of at least one of: the one or more MN-SIDs or the one or more SID rules.

14. The CN node of claim 13, wherein the transceiver and the processor are further configured to:
receive a notification indicative of a change in the one or more SIIs,
generate an updated SID request message based on the change in the one or more SIIs, and
transmit the updated SID request message to the SIDNF.

15. The CN node of claim 11, wherein the one or more SID rules include:
the one or more MN-SIDs,
a behavior information element (IE) indicative of a function for processing the one or more MN-SIDs, and
one or more arguments associated with the function.

16. The CN node of claim 11, wherein determining use of the SRBMN comprises:
receiving one or more policies from a policy control function (PCF), and
determining the use of the SRBMN based on at least one policy of the one or more policies.

17. The CN node of claim 11, wherein the CN node is a session management function (SMF) node.

18. A wireless transmit/receive unit (WTRU) comprising:
a memory;
a transceiver; and
a processor, wherein the transceiver and the processor are configured to:
receive, from a core network (CN) node, a policy message comprising a mobile network segment identifier (MN-SID) label application policy, wherein the MN-SID label application policy comprises a traffic detection portion and a label portion,
select a protocol data unit (PDU) session,
on a condition that a PDU associated with the PDU session matches the traffic detection portion of the MN-SID label application policy,
insert, in the PDU, an MN-SID indicated by the label portion of the MN-SID label application policy, and
transmit the PDU to the CN node.

19. The WTRU of claim 18, wherein the transceiver and processor are configured to:
insert the MN-SID to each PDU associated with the PDU session, and
transmit the each PDU to at least one of: a first RAN node or a second RAN node.

20. The WTRU of claim 18, wherein selecting the PDU session further comprises:
detecting one or more traffic characteristics of one or more PDU sessions,
evaluating at least one WTRU route selection policy (URSP) comprising a traffic descriptor, and
selecting the PDU session of the one or more PDU sessions associated with a traffic characteristic of the one or more traffic characteristics that matches the traffic descriptor.
